(19) United States
(12) Patent Application Publication
(10) Pub. No.: US 2013/0149642 A1
(43) Pub. Date: Jun. 13, 2013

(54) TONER AND DEVELOPER

(71) Applicants: Akiyoshi SABU, Shizuoka (JP); Yoshihiro MORIYA, Shizuoka (JP); Taichi NEMOTO, Shizuoka (JP); Yoshitaka YAMAUCHI, Shizuoka (JP); Yukiko NAKAJIMA, Kanagawa (JP); Keiji MAKABE, Shizuoka (JP); Suzuka AMEMORI, Shizuoka (JP); Daiki YAMASHITA, Kanagawa (JP); Masahide YAMADA, Shizuoka (JP)

(72) Inventors: Akiyoshi SABU, Shizuoka (JP); Yoshihiro MORIYA, Shizuoka (JP); Taichi NEMOTO, Shizuoka (JP); Yoshitaka YAMAUCHI, Shizuoka (JP); Yukiko NAKAJIMA, Kanagawa (JP); Keiji MAKABE, Shizuoka (JP); Suzuka AMEMORI, Shizuoka (JP); Daiki YAMASHITA, Kanagawa (JP); Masahide YAMADA, Shizuoka (JP)

(21) Appl. No.: 13/682,022

(22) Filed: Nov. 20, 2012

(30) Foreign Application Priority Data
Dec. 7, 2011 (JP) 2011-267858

(51) Int. Cl. G03G 9/087

(52) U.S. Cl. CPC G03G 9/08755; Y10S 977/773; B82Y 30/00
USPC 430/109.4; 977/773

(57) ABSTRACT

To provide a toner, which contains a first binder resin, and a second binder resin, wherein the first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min, wherein the Tg1 is −20° C. to 20° C., and the Tg2 is 35° C. to 65° C., and wherein the second binder resin is a crystalline resin.

### BACKGROUND OF THE INVENTION

1. Field of the Invention

The present invention relates to a toner and a developer for use in electrophotographic image formation, such as copying machines, latent electrostatic printing, printers, facsimiles, and latent electrostatic recording.

2. Description of the Related Art

In electrophotographic apparatuses and electrostatic recording apparatuses, electric or magnetic latent images have been conventionally developed into images by using a toner. In electrophotography, for example, an electrostatic image (latent image) is formed on a photoconductor, and then latent image is developed with a toner to form a toner image. Typically, the toner image is transferred onto a transfer material such as paper and then fixed by a method, such as heating.

Among components constituting the toner, a binder resin occupies 70% by mass or more of the toner. Since most of starting materials of binder resins are oil resources, there are concerns of depletion of the oil resources and the issue of global warming caused by discharge of a carbon dioxide gas into the air due to heavy consumption of the oil resources. If as a toner binder, an environmentally circulated polymer, which use a plant grows using carbon dioxide gas in the air, can be used, the carbon dioxide as generated is circulated in the environment. Therefore, there is possibility that use of such toner binder may satisfy both suppression of global warming and solution to depletion of the oil resources. Therefore, polymers derived from plant resources (i.e., biomass) have been receiving attention recently.

As a toner binder using a plant-derived resin, for example, disclosed is a toner using polylactic acid as a binder resin (see Japanese Patent (JP-B) No. 2909873). Polylactic acid is a commonly-used, easily-available polymer formed from plant resources as raw materials. It is known that polylactic acid is synthesized through dehydration condensation of lactic acid monomers or through ring-opening polymerization of cyclic lactides of lactic acids (see JP-B No. 3347406, and Japanese Patent Application Laid-Open (JP-A) No. 59-96123). However, when the polylactic acid is used for a toner as it is, the polylactic acid has high ester group concentration compared to a polyester resin, and a molecular chain bonded via an ester bond is composed of only a carbon atom (N=1). Accordingly, it is difficult to achieve physical properties and thermal characteristics required for a toner only with polylactic acid. To solve this problem, it is considered that physical properties and thermal characteristics necessary for a toner are secured by mixing or copolymerizing polylactic acid with another second binder resin. For example, proposed is to add a terepene-phenol copolymer as a low molecular weight component to a polylactic acid biodegradable resin (see JP-B No. 3785011). However, the disclosed does not satisfy low temperature fixing ability and hot offset resistance at the same time, and therefore use of the polylactic acid resin as a toner binder has not been realized. Further, polylactic acid has extremely poor compatibility and/or dispersibility with commonly used polyester resins and styrene-acryl copolymers. In the case where polylactic acid is used in combination with these resins, therefore, it is extremely difficult to control a formulation of an outer surface of a toner, which contributes important properties of a toner, such as storage stability, charging ability, and flowability.

Furthermore, crystallization kinetic of polylactic acid is slow, and therefore it is difficult to control a crystalline state of polylactic acid in a toner containing polylactic acid, produced by a dissolution resin suspension method. As a result, there are cases where polylactic acid having high crystallinity and polylactic acid having low crystallinity are mixed in a toner. In such case, crystals grow in the part containing polylactic acid having low crystallinity over time, and therefore there is a problem that the charging amount and image density change over time when such toner is used.

Moreover, there are optical isomers of polylactic acid, and polylactic acid containing only L-form or D-form has been a problem that it has high crystallinity and does not melt at low temperature. To solve this problem, proposed is racemizing polylactic acid so that it can melt at low temperature (see JP-A No. 2008-262179). This is an effective method for attaining low temperature fixing ability, but the resulting polylactic acid is still a resin having low glass transition temperature compared to conventional petroleum derived oil, and therefore it has poor heat resistant storage stability.

To solve this problem, proposed is a method for using a racemic body of polylactic acid, and giving core-shell structure to a toner to thereby provide desirable fixing characteristics and heat resistant storage stability (see JP-A No. 2010-014757). This proposal is an effective method for solving, by covering a surface of a toner with a shell, another problem associated with polylactic acid, which is that a charging amount is low and unstable because a concentration of hydrophilic ester groups is high.

However, a conventional unmodified racemic body of polylactic acid has low glass transition temperature, and therefore aggregates of the toner particles are formed in relatively high temperature environments, such as during summer. A factor therefore includes easy deformation of a resin itself, which is used in toner base particles. Not only during the long term storage in a standing state, but also during continuous printing, dynamic load, such as stirring and compression, as mechanical load in a printer, is applied to a toner, which adversely affects image quality, such as low image density, occurrence of transfer unevenness, and poor fine line reproducibility.

However, it was not yet realized a toner containing a polylactic acid resin and having excellent low temperature fixing ability and heat storage stability with less reduction in image density during continuous printing, and associated technologies thereof. Therefore, there is a need for further improvement and development thereof.

### SUMMARY OF THE INVENTION

The present invention aims to solve the aforementioned problems in the art, and to achieve the following object. An object of the present invention is to provide a toner, which is a polylactic acid-based toner, has excellent low temperature fixing ability and heat resistant storage stability, inhibits reduction in image density during continuous printing and occurrences of uneven transfer, and is excellent in reproducibility of fine lines.

Means for solving the aforementioned problems are as follows:

The toner of the present invention contains:

a first binder resin, and

a second binder resin,

wherein the first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min,

wherein the Tg1 is −20° C. to 20° C., and the Tg2 is 35° C. to 65° C., and

wherein the second binder resin is a crystalline resin.

The present invention can solve the aforementioned problems in the art, achieve the aforementioned object, and provide a toner, which is a polylactic acid-based toner, has excellent low temperature fixing ability and heat resistant storage stability, inhibits reduction in image density during continuous printing and occurrences of uneven transfer, and is excellent in reproducibility of fine lines.

### BRIEF DESCRIPTION OF THE DRAWINGS

FIG. 1 is a graph depicting a thermogram of a typical first binder resin for use in the present invention for 2nd Heating as measured by a differential scanning calorimeter at a heating rate of 5° C./min, and Tg1, Tg2, h1, and h2 thereof.

FIG. 2 is a phase image of the first binder resin used in Example 1, which is measured by tapping mode AFM.

FIG. 3 is a binarized image obtained through a binarizing process of the phase image of FIG. 2.

### DETAILED DESCRIPTION OF THE INVENTION

### (Toner)

The toner of the present invention contains a first binder resin and a second binder resin, and may further contain other components, if necessary.

### <First Binder Resin>

The first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min, where the Tg1 is −20° C. to 20° C., and the Tg2 is 35° C. to 65° C.

In order to fix a toner to a fixing medium, such as recording medium, by heating, a binder resin in a toner needs to be in a state that it can be adhered to the fixing medium at the set temperature for fixing. To this end, the amorphous binder resin needs to transform at least from a glass state to a rubber state, to exhibit a certain level of fluidity or adhesiveness. In order to fix the toner at lower temperature, the glass transition temperature Tg of the binder resin needs to be set lower than the temperature actually used, and therefore blocking, which means toner particles are fused to each other, is easily caused during storage. On the other hand, in order to prevent toner blocking in the range of temperature actually used, the glass transition temperature needs to be set at temperature equal to or higher than the temperature actually used. Accordingly, achieving low temperature fixing ability and storage stability of a toner is a relationship of trade-off.

The aforementioned problems in the art are caused due to low glass transition temperature of a resin, and low resistance of the resin to mechanical load. Therefore, as means for solving the problems, modification of a resin, and mixing the resin with another material are considered.

In the present invention, by using a block polymer containing at least a polyester skeleton A having a constitutional unit formed by dehydration condensation of hydroxycarboxylic acid in a repeating structure thereof, and a skeleton B that does not have a constitutional unit formed by dehydration condensation of hydroxycarboxylic acid in a repeating structure thereof, as a binder resin, low Tg units that exhibit low temperature fixing ability are finely dispersed in a phase of high Tg units that act effectively on storage stability of a toner, within an inner portion of a toner particle. As a result of this structure, low temperature fixing ability and storage stability, which generally has a relationship of trade-off, are both attained.

### <<Polyester Skeleton A Having Constitutional Unit Formed by Dehydration Condensation of Hydroxycarboxylic Acid in Repeating Structure Thereof>>

The polyester skeleton A having a constitutional unit formed by dehydration condensation of hydroxycarboxylic acid in a repeating structure thereof (may referred to as “polyester skeleton A” hereinafter) is appropriately selected depending on the intended purpose without any limitation, provided that it has, in its repeating structure thereof, a constitutional unit in which hydroxycarboxylic acid is dehydration condensed and/or (co)polymerized. Examples thereof include polyhydroxycarboxylic acid skeleton. Examples of a method for forming the polyester skeleton A include: a method in which hydroxycarboxylic acid is directly subjected to dehydration condensation; and a method in which a corresponding cyclic ester is subjected to ring-opening polymerization. Among these methods, the method for ring-opening polymerizing cyclic ester is preferable in order to increase a molecular weight of polyhydroxycarboxylic acid as polymerized.

A monomer that is a starting material of the polyester skeleton A is appropriately selected depending on the intended purpose without any limitation, but it is preferably aliphatic hydroxycarboxylic acid, more preferably C2-C6 hydroxycarboxylic acid in view of a transparency and thermal characteristics of a resulting toner. Examples of C2-C6 hydroxycarboxylic acid include lactic acid, glycolic acid, 3-hydroxylactic acid, and 4-hydroxy lactic acid. Among them, lactic acid is particularly preferable because it gives appropriate glass transition temperature, and a resin thereof has excellent transparency and affinity to a colorant.

In addition to hydroxycarboxylic acid, a raw material of the polyester skeleton A may be a cyclic ester of hydroxycarboxylic acid. In this case, the polyester skeleton A of a resin obtained through polymerization is a skeleton where hydroxycarboxylic acid forming the cyclic ester is polymerized. For example, the polyester skeleton A of a resin obtained using lactide (lactide of lactic acid) is a skeleton of lactic acid polymerized. The polyester skeleton A is preferably a skeleton obtained by subjecting a mixture of L-lactide and D-lactide to ring-opening polymerization.

The polyester skeleton A is not particularly limited and may be appropriately selected depending on the intended purpose, but is preferably a polylactic acid skeleton. Polylactic acid is a polymer formed of lactic acids linked via an ester bond, and has recently attracted attention as environmentally-friendly biodegradable plastics. That is, in the natural world, enzymes that cleave ester bonds (esterases) are widely distributed. Thus, polylactic acids are gradually cleaved by such enzymes in the environment and then converted to lactic acids (i.e., monomers), which are finally converted carbon dioxide and water.

A production method of the polylactic acid is not particularly limited, and can be selected from the methods known in the art. Examples of the production method thereof include: a method including fermenting starch, such as of corn, serving as a starting material, to obtain lactic acid, and directly performing dehydration concentration on the lactic acid; and a method including obtaining cyclic dimmer lactide from lactic acid, and synthesizing polylactic acid from the cyclic dimmer lactic by performing ring-opening polymerization in the presence of a catalyst. Among them, the method for producing the polylactic acid by ring-opening polymerization is preferable because of productivity, such that a molecular weight of the polylactic acid can be controlled with an amount of an initiator, and a reaction can be completed within a short period.

As for a reaction initiator, any initiators known in the art can be used regardless of a number of functional groups, as long as it is an alcohol component that is not evaporated when vacuum drying at 100° C. and 20 mmHg or lower, or heating for polymerization at about 200° C. is performed.

In the polylactic acid skeleton, the optical purity X (%) calculated by the following equation (as converted to monomer components) is preferably 80% or lower:

X(%)=|X(L form)−X(D form)|

where X (L form) denotes a ratio (%) of L form (hydroxycarboxylic acid monomer equivalent) and X (D form) denotes a ratio (%) of D form (hydroxycarboxylic acid monomer equivalent).

The optical purity X of 80% or lower is preferable as solubility to a solvent, and transparency of a resin is improved. When the optical purity X is more than 80%, the crystallinity becomes high and therefore it is difficult to melt at low temperature, which may lead to poor low temperature fixing ability of a resulting toner.

The method of measuring the optical purity X is not particularly limited and may be appropriately selected depending on the intended purpose. For example, the optical purity X can be found in the following manner. A polymer or toner that has a polyester skeleton is added to a mixture solvent consisting of pure water, 1N sodium hydroxide solution and isopropyl alcohol. The mixture is then heated to 70° C. and stirred for hydrolysis. Next, the mixture is subjected to filtration to remove solids, followed by adding sulfuric acid for neutralization, to thereby yield an aqueous solution containing L-hydroxycarboxylic acid and/or D-hydroxycarboxylic acid that have been produced by decomposition of the polyester. The aqueous solution is subjected to high-performance liquid chromatography (HPLC) on a SUMICHIRAL OA-5000 column, a chiral ligand-exchange column (manufactured by Sumika Chemical Analysis Service, Ltd.). Then, peak area S (L) derived from L-hydroxycarboxylic acid and peak area S (D) derived from D-hydroxycarboxylic acid are calculated. Using these peak areas, it is possible to find the optical purity X as follows:

X(L form)%=100×S(L)/(S(L)+S(D))

X(D form)%=100×S(D)/(S(L)+S(D))

Optical purity X%=|X(L form)−X(D form)|

Needless to say, L-form and D-form, serving as starting materials, are optical isomers which have the same physical and chemical properties except optical properties. When they are used for polymerization, their reactivities are equal to each other, and the compositional ratio of the monomers as starting materials is the same as the compositional ratio of the monomers in the polymer.

The ratio between X of a D-form monomer and X of an L-form monomer constituting the polyester skeleton A is equal to the ratio between a D-form monomer and an L-form monomer used for forming the polyester skeleton A. Thus, the optical purity X (%) of the polyester skeleton A of the binder resin as converted to monomer components can be achieved by preparing a racemic body by using, as monomers, an appropriate amount of L-form thereof and an appropriate amount of D-form in combination.

The mass ratio of the polyester skeleton A in the first binder resin is appropriately selected depending on the intended purpose without any limitation, but it is preferably 40% by mass to 80% by mass, more preferably 55% by mass to 70% by mass. When the mass ratio thereof is greater than 80% by mass, sufficient heat resistant storage stability may not be attained. When the mass ratio thereof is less than 40% by mass, desirable low temperature fixing ability may not be attained.

<<Skeleton B that does not have Constitutional Unit Formed by Dehydration Condensation of Hydroxycarboxylic Acid in Repeating Structure Thereof>>

In the present invention, the skeleton B that does not have a constitutional unit formed by dehydration condensation of hydroxycarboxylic acid in a repeating structure thereof (may be referred to as “skeleton B” hereinafter) has at least glass transition temperature of 20° C. or lower. As a result of this, a structure in which an inner phase is dispersed in an outer phase can be formed, where the outer phase is mainly composed of the polyester skeleton A of the binder resin, and the inner phase is mainly composed of the skeleton B. The skeleton B is preferably a compound having two or more hydroxyl groups, and the first binder resin can be obtained through ring-opening polymerization of lactide using, as an initiator, the skeleton B having two or more hydroxyl groups. By using the compound having two or more hydroxyl groups as the skeleton B, affinity to a colorant can be improved. In addition, by providing high Tg units derived from the skeleton A to both terminals, the aforementioned skeleton of a binder resin in which the low Tg units are easily dispersed can be formed.

The skeleton B is appropriately selected depending on the intended purpose without any limitation, provided that it does not contain, in its repeating structure, a constitutional unit formed through dehydration condensation of the hydroxycarboxylic acid. Examples thereof include polyether, polycarbonate, polyester, a vinyl resin containing a hydroxyl group, and a silicone resin containing a terminal hydroxyl group. Among them a polyester skeleton is particularly preferably in view of affinity to a colorant. These may be used alone or in combination.

The polyester skeleton is obtained by ring-opening addition polymerization of a polyesterified product of one or more polyols represented by the following general formula (1) with one or more polycarboxylic acids represented by the following general formula (2).

A-(OH)ₘ General Formula (1)

In the general formula (1), A is a C1-C20 alkyl group or alkylene group, or an aromatic group or heterocyclic aromatic group which may have a substituent, and m is an integer of 2 to 4.

B—(COOH)ₙ General Formula (2)

In the general formula (2), B is a C1-C20 alkyl group or alkylene group, or an aromatic group or heterocyclic aromatic group which may have a substituent, and n is an integer of 2 to 4.

Examples of the polyol represented by the general formula (1) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentane triol, glycerol, 2-methylpropane triol, 2-methyl-1,2,4-butane triol, trimethylol ethane, trimethylol propane, 1,3,5-trihydroxymethyl benzene, bisphenol A, bisphenol A ethylene oxide adducts, bisphenol A propylene oxide adducts, hydrogenated bisphenol A, hydrogenated bisphenol A ethylene oxide adducts, and hydrogenated bisphenol A propylene oxide adducts. These may be used alone or in combination.

Examples of the polycarboxylic acid represented by the general formula (2) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isooctyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Enpol trimer acid, cyclohexanedicarboxylic acid, cyclohexenedicarboxylic acid, butanetetracarboxylic acid, diphenylsulfonetetracarboxylic acid, and ethylene glycol bis(trimellitic acid). These may be used alone or in combination.

Among these polycarboxylic acids listed above, trimellitic acid is particularly preferable because it is possible to give an appropriate branched and/or crosslink structure, and a substantial molecular chain can be made short due to the branched structure. By incorporating the trimellitic acid, a size of a domain of the skeleton B (the average diameter of the later-described fist phase difference regions), which is dispersed in an inner phase can be controlled small.

An amount of the trimellitic acid in the polyester skeleton is preferably 1.5 mol % to 3.0 mol %. When the amount thereof is less than 1.5 mol %, a branched structure is provided insufficiently, the domain size (the average diameter of the first phase difference regions, described later) of the skeleton B becomes larger than necessary, which may adversely affect heat resistant storage stability of a resulting toner. When the amount thereof is more than 3.0 mol %, moreover, a provided branched or crosslinked structure becomes complicated and therefore a molecular weight of the resin increases, which may adversely affect solubility to a solvent.

The skeleton B preferably has a certain molecular weight and a certain mass ratio. The mass ratio of the skeleton B in the first binder resin is preferably 25% by mass to 50% by mass, more preferably 25% by mass to 40% by mass.

The number average molecular weight Mn (B) of the skeleton B is preferably 3,000 to 5,000, more preferably 3,000 to 4,000.

When the mass ratio is less than 25%, or the number average molecular weight Mn of the skeleton B is less than 3,000, the average diameter of the first phase difference regions, which correspond to the parts having large phase differences as measured by tapping mode AFM, becomes too small. As a result, the resin may be difficult to have two grass transition temperature, and therefore desirable low temperature fixing ability of a resulting toner may not be achieved. When the mass ratio is greater than 50% by mass, or the number average molecular weight of the skeleton B is greater than 5,000, the average diameter becomes too large, and therefore blocking between toner particles may occur due to long term storage.

Note that, the number average molecular weight can be measured, for example, by gel permeation chromatography (GPC).

### <<Glass Transition Temperature of First Binder Resin>>

The glass transition temperature of the first binder resin can be determined from an endothermic chart obtained by a differential scanning calorimeter (DSC). Examples of the DSC include Q2000 (manufactured by TA Instruments).

Specifically, a readily sealable aluminum pan is charged with 5 mg to 10 mg of a binder resin, and the binder resin in the pan is subjected to the following measuring flow:

1st Heating: 30° C. to 220° C., 5° C./min., where after reaching 220° C., the sample is maintained at 220° C. for 1 min;

Cooling: the sample is quenched to −60° C. without being temperature-controlled, where after reaching −60° C., the sample is maintained at −60° C. for 1 min; and

2nd Heating: −60° C. to 180° C., 5° C./min.

The glass transition temperature is obtained by reading a value in a thermogram for 2nd Heating with the mid-point method specified in ASTM D3418/82. In this method, the glass transition temperature observed at the lower temperature side is defined as Tg1, and the glass transition temperature observed at the higher temperature side is defined as Tg2. Notably, the glass transition temperature is preferably identified by determining the inflection point from the DrDSC chart which has been subjected to first derivation. The differences in the heat flow rate between base lines for two glass transition temperature (Tg1 and Tg2) in the thermogram obtained through the 2nd Heating, which are respectively defined as h1 and h2, can be each determined from a difference between the onset point and endset point of each glass transition temperature, where the onset point is present on the lower temperature side and the endset point is present on the higher temperature side.

The onset point and the endset point can be measured, for example, by a method in accordance with JIS K 7121, or ASTM 3418.

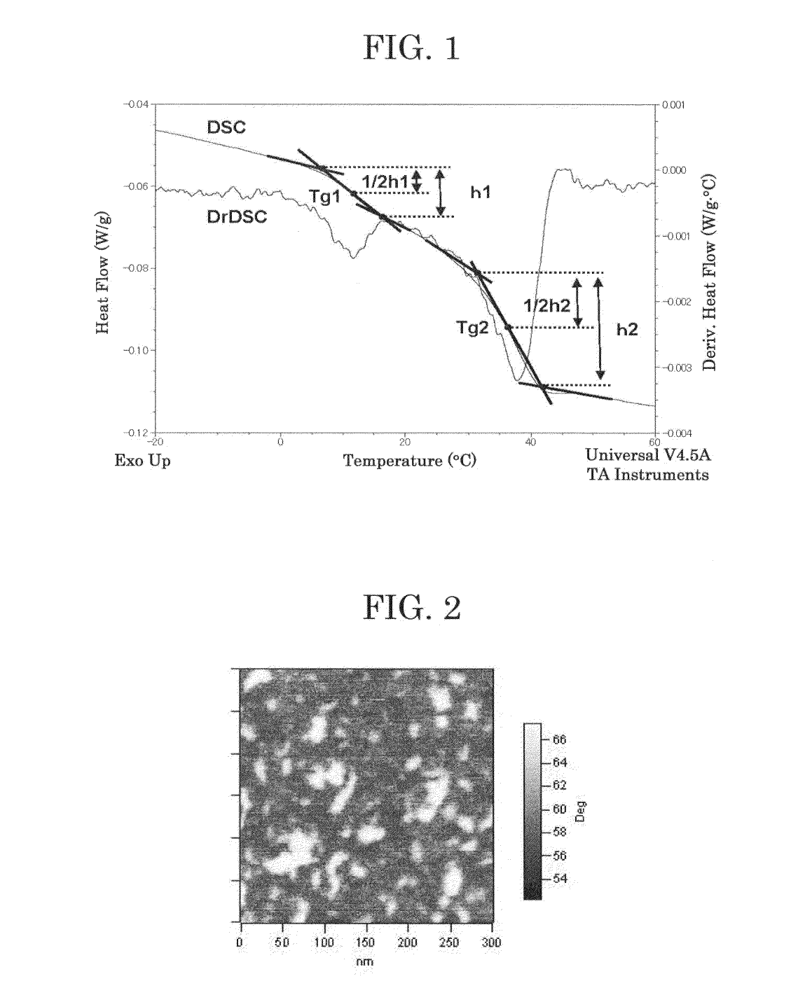

The thermogram of the typical binder resin of the present invention for 2nd Heating, and definitions of Tg1, Tg2, h1, and h2 therein are depicted in FIG. 1.

### —Glass Transition Temperature Tg1 and Tg2—

The glass transition temperature Tg1 of the first binder resin of the lower temperature side is −20° C. to 20° C. When the Tg1 is lower than −20° C., toner blocking may occur during storage. When the Tg1 is higher than 20° C., a difference in thermal properties with the higher Tg region provided on the outer side to protect the region of Tg 1 is small, which may impair low temperature fixing ability.

The glass transition temperature Tg2 of the first binder resin of the higher temperature side is 35° C. to 65° C., preferably 45° C. to 60° C. When the Tg2 is lower than 35° C., a function of protecting the low Tg region having excellent low temperature fixing ability may not be exhibited, and therefore toner blocking may occur. When the Tg2 is higher than 65° C., a function of protecting is effectively exhibited, but bleeding of the encapsulated low Tg unit is inhibited during fixing, which may greatly impair fixing ability.

—Ratio h1/h2 of Differences h1 and h2 in Heat Flow Rate Between Base Lines—

A ratio h1/h2 is preferably less than 1.0, where h1 is a difference in a heat flow rate between base lines for the glass transition temperature Tg1 and h2 is a difference in a heat flow rate between base lines for the glass transition temperature Tg2. In the aforementioned structure where low Tg units are dispersed, Tg1 and Tg2 do not necessarily correspond to the glass transition temperature of the skeleton B, and that of the polyester skeleton A, respectively. The morphology of the inner area of the binder resin is set by providing partial affinity, or micro phase separation structure. The glass transition temperature observed in such structure appears as an intermediate value of the glass transition temperatures of the skeleton B and the polyester skeleton A. From the same reason as mentioned, moreover, the ratio h1/h2 of the base lines is not necessarily determined with a weight ratio of formulated amounts thereof. The ratio h1/h2 represents a substantial ratio of the low Tg units to the high Tg units in the finally generated binder resin, and this ratio is preferably less than 1.0. When the ratio h1/h2 is 1.0 or more, a proportion of the low Tg units increases, which may cause toner blocking. In an extreme case, a reverse phase separation structure, where the high Tg units are dispersed in the low Tg unit, is formed. Therefore, the ratio h1/h2 of 1.0 or more is not preferable.

### <<Phase Image of Tapping Mode Atomic Force Microscopy (AFM)>>

The first binder resin has a structure where the units having Tg1, which have excellent low temperature fixing ability, are finely dispersed in the unit having Tg2, which has excellent shelf stability. This dispersion state can be confirmed with a phase image obtained by a tapping mode atomic force microscopy (AFM). The tapping mode atomic force microscopy is also called as an intermittent-contact mode or dynamic force microscopy (DFM), and is a method described in Surface Science Letter, 290, 668 (1993). The phase image obtained by the tapping mode is, for example, explained in Polymer, 35, 5778 (1994), and Macromolecules, 28, 6773 (1995). Specifically, it is a method for measuring a profile of a surface of a sample with oscillated a cantilever. During the measurement, a phase difference is formed between the drive which is an oscillating source of the cantilever, and the actual oscillation, due to the viscoelastic characteristics of the surface of the sample. Specifically, a large delay in the phase is observed with a soft part, and a small delay in the phase is observed with a hard part. A phase image is an image mapping these phase differences.

In the first binder resin, the unit having low Tg is softer and is appeared in an image as having a large phase difference, and the unit having high Tg is harder and is appeared in an image as having a small phase difference. Here, the first binder resin has a structure where the second phase difference region, which corresponds to a hard low phase difference part, is present in an outer phase, and the first phase difference region, which is correspond to a soft high phase difference part, is present in an inner phase and finely dispersed. In other words, a binarized image of a phase image of the first binder resin preferably contains first phase difference regions each formed of a first pixels and a second phase difference region formed of second pixels where the first phase difference regions are dispersed in the second phase difference region, wherein the binarized image of the phase image of the first binder resin is obtained through a process containing: measuring the first binder resin by a tapping mode atomic force microscopy to obtain phase differences at parts of the binder resin; converting the phase differences into image densities of pixels so that the parts having smaller phase differences are dark colored and the parts having greater phase differences are light colored; and mapping the parts to obtain the phase image; and subjecting the phase image to binarization using, as a threshold, an intermediate value between a maximum value and a minimum value of the image densities, so that the image densities of the first pixels are equal to or more than the minimum value but less than the intermediate value and the image densities of the second pixels are equal to or more than the intermediate value but equal to or less than the maximum value.

More specifically, it is preferred that the first phase difference regions, which are white parts, be dispersed in the black second phase difference region in a black and white image, which is obtained by imaging the phase image to show a contrast in a color tone so that the part having a small phase difference is represented with a dark color, and the part having a large phase difference is represented with a light color; and subjecting the phase image to binarization using, as a threshold, an intermediate value of the maximum value of the phase difference and the minimum value of the phase difference in the phase image to obtain a black and white image.

A sample observed for obtaining the phase image may be a cut piece of a block of the binder resin which is prepared under the following conditions using, for example, an ultramicrotome ULTRACUT UCT (product of Leica):

Cutting thickness: 60 nm

Cutting speed: 0.4 mm/sec

Diamond knife (Ultra Sonic 35°) used

A typical device used for obtaining the AFM phase image includes, for example, MFP-3D (product of Asylum Technology Co., Ltd.), in which OMCL-AC240TS-C3 is used as a cantilever to observe under the following measurement conditions:

Target amplitude: 0.5 V

Target percent: −5%

Amplitude set point: 315 mV

Scan rate: 1 Hz

Scan points: 256×256

Scan angle: 0°

Examples of the method for converting the phase difference image into the binarized image include a method, in which phase differences in parts of the phase difference image are subjected to linear transformation and mapping using an image editing software (e.g., Adobe Photoshop CS, of Adobe Systems Inc.) so that the parts having small phase differences are represented with dark color, and the parts having large phase differences are represented with light color.

### —Average Diameter of First Phase Difference Regions—

The average, diameter of the first phase difference regions (i.e., soft low Tg units) is defined as the average value of the maximum Feret diameters of the 30 first phase difference regions, which are selected from those having the largest diameter in the binarized image. However, images of very small diameters, which are clearly judged as image noise, or are difficult to determine whether they are image noise or phase difference regions are excluded from targets for calculation of the average diameter. Specifically, the first phase difference regions that should be excluded from calculation of the average diameter are those having an area of 1/100 or smaller than the first phase difference region having the greatest maximum Feret diameter in the same image of the observed binarized image.

The maximum Feret diameter is a distance between two parallel lines drawn so as to sandwich each phase difference region.

As a specific method for measuring the average diameter, it can be measured by forming a binarized image of a phase image obtained by tapping mode AFM.

As described above, the binarized image can be formed by imaging the phase image to show a contrast in a color tone so that the part having a small phase difference is represented with a dark color, and the part having a large phase difference is represented with a light color; and subjecting the phase image to binarization using, as a threshold, an intermediate value of the maximum value of the phase difference and the minimum value of the phase difference in the phase image to obtain a black and white image.

The average diameter is preferably 100 nm or less, more preferably 20 nm to 100 nm. When the average diameter thereof is greater than 100 nm, blocking of a toner during storage. When the average diameter thereof is less than 20 nm, low temperature fixing ability of a toner may be low.

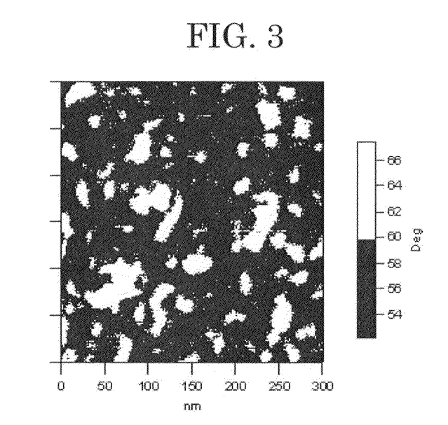

Note that, the phase image of a typical first binder resin for use in the present invention, as obtained by tapping mode AFM is presented in FIG. 2, and the binarized image obtained by binarization of the phase image is presented in FIG. 3.

### <<Molecular Weight of First Binder Resin>>

The number average molecular weight of the first binder resin is preferably 25,000 or less, more preferably 8,000 to 20,000. When the number average molecular weight thereof is greater than 25,000, the solubility to a solvent may be poor as well as imparting low fixing ability to a resulting toner.

The number average molecular weight can be measured, for example, by gel permeation chromatography (GPC).

### <Second Binder Resin>

The second binder resin is a crystalline resin. Similarly to the first binder resin, the second binder resin has low glass transition temperature, but since the second binder resin is a crystalline resin having high strength, the second binder resin becomes compatible to the low Tg units of the binder resin to thereby maintain mechanical strength.

A type of the crystalline resin is appropriately selected depending on the intended purpose without any limitation, and examples thereof include a polyester resin, a silicone resin, a styrene-acryl resin, a styrene resin, an acrylic resin, an epoxy resin, a diene resin, a phenol resin, a terpene resin, a cumarin resin, an amide resin, an amide-imide resin, a butyral resin, a urethane resin, and an ethylene-vinyl acetate resin. Among them, a polyester resin is preferable because use of such resin realizes sharp-melt during fixing to smooth a surface of an image, and the polyester resin has sufficient flexibility with low molecular weight, and a polyester resin that does not contains, in its repeating structure, a constitutional unit formed by dehydration condensation of hydroxycarboxylic acid is particularly preferable. Note that, other resins may be further used in combination with the polyester resin.

The crystalline polyester is sharply melted at around a melting point thereof, and therefore the crystalline polyester greatly affects low temperature fixing ability of a resulting toner. As for the crystalline polyester, preferred is an aliphatic polyester resin synthesized using aliphatic diol and aliphatic dicarboxylic acid as main components, in order to form a crystalline structure and to attain high sharp melt characteristics, which is a main effect of the crystalline polyester. In the present invention, particularly preferred is an aliphatic polyester resin synthesized using an alcohol component including C2-C6 straight chain alkylene glycol (e.g., ethylene glycol, 1,4-butanediol, and 1,6-hexanediol) and derivatives thereof, and an acid component including an aliphatic dicarboxylic acid compound (e.g., maleic acid, fumaric acid, succinic acid, and sebacic acid) and derivatives thereof.

Moreover, in order to synthesize a non-linear polyester resin as the crystalline polyester, condensation polymerization may be performed by adding trihydric or higher polyhydric alcohol such as glycerin to the alcohol component, or a small amount (10% by mass or less relative to the crystalline polyester) of trivalent or higher polyvalent carboxylic acid such as trimellitic anhydride to the acid component.

The crystallinity in the crystalline polyester can be confirmed with a diffraction pattern obtained by a powder X-ray diffractometer. The diffraction pattern of the crystalline polyester has at least three diffraction peaks in the region of at least 2θ=19° to 25°.

The diffraction pattern can be confirmed, for example, by measuring a powder by means of an X-ray diffractometer (RINT-1100, manufactured by Rigaku Corporation) using a standard sample holder for XRD under the following conditions.

Bulb: Cu

Bulb voltage and current: 50 KV-30 mA

Goniometer: wide-angle goniometer

Sampling width: 0.020°

Scanning speed: 2.0°/min

Scanning range: 5° to 50°

Note that the presence of the diffraction peaks are determined by searching peaks processed with a smoothing point of 11, and judging based on present or absence of the detected peaks.

An amount of the second binder resin is appropriately selected depending on the intended purpose without any limitation, but it is preferably 10 parts by mass to 60 parts by mass, more preferably 15 parts by mass to 50 parts by mass, relative to 100 parts by mass of the first binder resin.

When the amount thereof is less than 10 parts by mass, the toner particles may be cracked in a developing device, or toner particles may be fused to each other. When the amount thereof is more than 60 parts by mass, low temperature fixing ability may be impaired.

<<Modified Polyester Resin Reactive with Active Hydrogen Group-Containing Compound>>

The second binder resin is preferably formed by dispersing or emulsifying, in an aqueous medium, an active hydrogen group-containing compound and a modified polyester resin reactive with the active hydrogen group-containing compound, and allowing the active hydrogen group-containing compound and the modified polyester resin to carry out an elongation or crosslink reaction.

By using the crystalline polyester composed of a constitutional unit compatible to the low Tg unit, a terminal(s) of which is modified in combination, and introducing the crystalline polyester into an inner area of a toner particle by an elongation or crosslink reaction during granulation of a toner in the aforementioned manner, mechanical stress resistance of the low Tg unit can be improved. Moreover, toner spent of a toner containing a low Tg unit, which tends to occur, is prevented during continuous printing over a long period, and deterioration in image quality can be suppressed.

### —Active Hydrogen Group-Containing Compound—

The active hydrogen group-containing compound acts as an elongating agent or crosslinking agent during an elongation reaction or crosslink reaction of the modified polyester reactive with the active hydrogen group-containing compound in the granulation process performed in the aqueous medium.

The active hydrogen group-containing compound is appropriately selected depending on the intended purpose without any limitation, provided that it contains an active hydrogen group. For example, in the case where the modified polyester reactive with the active hydrogen group-containing compound is isocyanate group-containing modified polyester (A), the active hydrogen group-containing compound is preferably amine (B) as it can form a polymer of high molecular weight through a reaction (e.g., an elongation reaction, and a crosslink reaction) with the isocyanate group-containing modified polyester (A).

The active hydrogen group is appropriately selected depending on the intended purpose without any limitation, and examples thereof include a hydroxyl group (e.g., an alcoholic hydroxyl group, and a phenolic hydroxyl group), an amino group, a carboxyl group, and a mercapto group. These may be used alone or in combination. Among them, an alcoholic hydroxyl group is particularly preferable.

The amines (B) are appropriately selected depending on the intended purpose without any limitation, and examples thereof include diamine (B1), trivalent or higher polyamine (B2), amino alcohol (B3), amino mercaptan(B4), amino acid (B5), compounds in which the amino groups of (B1) to (B5) are blocked (B6).

These may be used alone or in combination. Among them, particularly preferred are diamine (B1), and a mixture of diamine (B1) and a small amount of trivalent or higher polyamine (B2).

Examples of the diamine (B1) include aromatic diamine, alicyclic diamine, and aliphatic diamine. Examples of the aromatic diamine include phenylene diamine, diethyl toluene diamine, and 4,4′-diaminodiphenyl methane. Examples of the alicyclic diamine include 4,4′-diamino-3,3′-dimethyldicyclohexyl methane, diaminocyclohexane, and isophorone diamine. Examples of the aliphatic diamine include ethylene diamine, tetramethylene diamine, and hexamethylene diamine.

Examples of the trivalent or higher polyamine (B2) include diethylene triamine, and triethylene tetramine.

Examples of the amino alcohol (B3) include ethanol amine, and hydroxyethyl aniline.

Examples of the amino mercaptan (B4) include aminoethyl mercaptan, and aminopropyl mercaptan.

Examples of the amino acid (B5) include aminopropionic acid, and aminocaproic acid.

Examples of the compound in which an amino group of (B1) to (B5) is blocked (B6) include a ketimine compound and oxazoline compound obtained with any of the amines of (B1) to (B5) and ketones (e.g., acetone, methyl ethyl ketone, and methyl isobutyl ketone).

Note that, in order to stop an elongation reaction, or crosslink reaction between the active hydrogen-group containing compound and modified polyester reactable with the active hydrogen-containing compound, a reaction terminator can be used. Use of the reaction terminator is preferable because a molecular weight or the like of the adhesive base material can be controlled to be in a desirable range. Examples of the reaction terminator include monoamine (e.g., diethyl amine, dibutyl amine, butyl amine, and lauryl amine), and a blocked compound thereof (e.g., a ketimine compound).

As for a mixing rate between the amines (B) and the isocyanate group-containing modified polyester (A), a mixing equivalent ratio ([NCO]/[NHx]) of isocyanate groups [NCO] in the isocyanate group-containing modified polyester (A) to amino groups [NHx] in the amines is preferably 1/3 to 3/1, more preferably 1/2 to 2/1, and even more preferably 1/1.5 to 1.5/1.

When the mixing equivalent ratio ([NCO]/[NHx]) is less than ⅓, low temperature fixing ability of a resulting toner may be poor. When the mixing equivalent ratio thereof is greater than 3/1, a molecular weight of the modified polyester is small, which may lead to poor offset resistance of a resulting toner.

### —Modified Polyester Resin—

A site in the modified polyester resin reactive to the active hydrogen group-containing compound (may be referred to as “prepolymer” hereinafter), which is reactive to the active hydrogen group-containing compound, is appropriately selected from substituents known in the art, without any limitation. Examples thereof include an isocyanate group, an epoxy group, carboxylic acid, and an acid chloride group. These may be contained alone or in combination in the prepolymer. Among them, an isocyanate group is particularly preferable.

Among the modified polyester resin, particularly preferred is a urea bond generating group-containing polyester resin (RMPE) because a molecular weight of a high molecular weight component is easily controlled, and oil-less low temperature fixing ability of a dry toner can be maintained, namely, excellent releasing properties and fixing ability of a dry toner can be maintained, even in a case where a fixing device does not have a system for coating releasing oil to a heating medium for fixing.

Examples of the urea bond generating group include an isocyanate group. In the case where the urea bond generating group in the urea bond generating group-containing polyester resin (RMPE) is an isocyanate group, the polyester resin (RMPE) is particularly preferably the isocyanate group-containing polyester prepolymer (A).

The isocyanate group-containing polyester prepolymer (A) skeleton is appropriately selected depending on the intended purpose without any limitation, and examples thereof include: one obtained by reacting an active hydrogen group-containing polyester, which is a polycondensation product of polyol (PO) and polycarboxylic acid (PC), with polyisocyanate; and one obtained by reacting a polycondensation product of polyol (PO) and polycarboxylic acid (PC) with cyclic ester to proceed to ring-opening addition polymerization, to thereby generate active hydrogen group-containing polyester, and reacting the active hydrogen group-containing polyester with polyisocyanate (PIC).

The polyol (PO) is appropriately selected depending on the intended purpose without any limitation, and examples thereof include diol (DIO), trihydric or higher polyol (TO), and a mixture of diol (DIO) and trihydric or higher polyol (TO). These may be used alone or in combination. Among them, preferred are the diol (DIO) alone, and a mixture of the diol (DIO) and a small amount of the trihydric or higher polyol (TO).

Examples of the diol (DIO) include alkylene glycol, alkylene ether glycol, alicyclic diol, an alkylene oxide adduct of alicyclic diol, bisphenol, and an alkylene oxide adduct of bisphenol.

As for the alkylene glycol, those containing 2 to 12 carbon atoms are preferable. Examples thereof include ethylene glycol, 1,2-propylene glycol, 1,3-propylene glycol, 1,4-butanediol, and 1,6-hexanediol.

Examples of the alkylene ether glycol include diethylene glycol, triethylene glycol, dipropylene glycol, polyethylene glycol, polypropylene glycol, and polytetramethylene ether glycol. Examples of the alicyclic diol include 1,4-cyclohexane dimethanol, and hydrogenated bisphenol A. Examples of the alkylene oxide adduct of the alicyclic diol include adducts obtained by adding alkylene oxide (e.g., ethylene oxide, propylene oxide, and butylene oxide) to any of the above-listed alicyclic diols. Examples of the bisphenols include bisphenol A, bisphenol F, and bisphenol S. Examples of the alkylene oxide adduct of bisphenol include alkylene oxide (e.g., ethylene oxide, propylene oxide, and butylene oxide) adducts of the above-listed bisphenols.

Among them, preferred are C2-C12 alkylene glycol, and an alkylene oxide adduct of bisphenol, and particularly preferred are an alkylene oxide adduct of bisphenol, and a mixture of an alkylene oxide adduct of bisphenol and C2-C12 alkylene glycol.

As for the trihydric or higher polyol (TO), trihydric to octahydric or higher polyol is preferable. Examples thereof include trihydric or higher polyhydric aliphatic alcohol, trihydric or higher polyphenol, and an alkylene oxide adduct of trihydric or higher polyphenol. Examples of the trihydric or higher polyhydric aliphatic alcohol include glycerin, trimethylol ethane, trimethylol propane, pentaerythritol, and sorbitol.

Examples of the trihydric or higher polyphenol include trisphenol PA, phenol novolak, and cresol novolak.

Examples of the alkylene oxide of trihydric or higher polyphenol include alkylene oxide (e.g. ethylene oxide, propylene oxide, and butylene oxide) adducts of the above-listed trihydric or higher polyphenols.

A blending mass ratio (DIO:TO) of the diol (DIO) to the trihydric or higher polyol (TO) in the mixture of the diol (DIO) and the trihydric or higher polyol (TO) is preferably 100:(0.01 to 10), more preferably 100:(0.01 to 1).

The polycarboxylic acid (PC) is appropriately selected depending on the intended purpose without any limitation, and examples thereof include dicarboxylic acid (DIC), trivalent or higher polycarboxylic acid (TC), and a mixture of dicarboxylic acid (DIC) and trivalent or higher polycarboxylic acid.

These may be used alone or in combination. Among them, preferred are dicarboxylic acid (DIC) alone, and a mixture of DIC and a small amount of the trivalent or higher polycarboxylic acid (TC).

Examples of the dicarboxylic acid include alkylene dicarboxylic acid, alkenylene dicarboxylic acid, and aromatic dicarboxylic acid.

Examples of the alkylene dicarboxylic acid include succinic acid, adipic acid, and sebacic acid.

As for the alkenylene dicarboxylic acid, those having 4 to 20 carbon atoms are preferable, and examples thereof include maleic acid, and fumaric acid.

As for the aromatic dicarboxylic acid, those having 8 to 20 carbon atoms are preferable, and examples thereof include phthalic acid, isophthalic acid, terephthalic acid, and naphthalene dicarboxylic acid.

Among them, preferred are C4-C20 alkenylene dicarboxylic acid, and C8-C20 aromatic dicarboxylic acid.

As for the trivalent or higher polycarboxylic acid (TO), those of trivalent to octavalent or higher are preferable, and examples thereof include aromatic polycarboxylic acid.

As for the aromatic polycarboxylic acid, those having 9 to 20 carbon atoms are preferable, and examples thereof include trimellitic acid, and pyromellitic acid.

As for the polycarboxylic acid (PC), acid anhydride or lower alkyl ester of any selected from the group consisting of the dicarboxylic acid (DIC), trivalent or higher polycarboxylic acid (TC), and a mixture of the dicarboxylic acid (DIC) and the trivalent or higher polycarboxylic acid can be also used.

Examples of the lower alkyl ester include methyl ester, ethyl ester and isopropyl ester.

A blending mass ratio (DIC:TC) of the dicarboxylic acid (DIC) to the trivalent or higher polycarboxylic acid (TC) in the mixture of the dicarboxylic acid (DIC) and the trivalent or higher polycarboxylic acid (TC) is appropriately selected depending on the intended purpose without any limitation, but for example, it is preferably 100:(0.01 to 10), more preferably 100:(0.01 to 1).

A blending ratio of the polyol (PO) and the polycarboxylic acid (PC) for a polycondensation reaction is appropriately selected depending on the intended purpose without any limitation. For example, an equivalent ratio ([OH]/[COOH]) of hydroxyl groups [OH] in the polyol (PO) to carboxyl groups [COOH] in the polycarboxylic acid (PC) is typically, preferably 2/1 to 1/1, more preferably 1.5/1 to 1/1, and even more preferably 1.3/1 to 1.02/1.

An amount of the polyol (PO) in the isocyanate group-containing polyester prepolymer (A) is appropriately selected depending on the intended purpose without any limitation, and for example, it is preferably 0.5% by mass to 40% by mass, more preferably 1% by mass to 30% by mass, and even more preferably 2% by mass to 20% by mass.

When the amount thereof is less than 0.5% by mass, hot offset resistance of a resulting toner may be poor, and therefore it is difficult to attain both heat resistant storage stability and low temperature fixing ability of the toner. When the amount thereof is greater than 40% by mass, low temperature fixing ability of a resulting toner may be insufficient.

The polyisocyanate (PIC) is appropriately selected depending on the intended purpose without any limitation, and examples thereof include aliphatic polyisocyanate, alicyclic polyisocyanate, aromatic diisocyanate, aromatic aliphatic diisocyanate, isocyanurate; and a block product thereof where the foregoing compounds are blocked with a phenol derivative, oxime, or caprolactam.

Examples of the aliphatic polyisocyanate include tetramethylene diisocyanate, hexamethylene diisocyanate, 2,6-diisocyanato methyl caproate, octamethylene diisocyanate, decamethylene diisocyanate, dodecamethylene diisocyanate, tetradecamethylene diisocyanate, trimethylhexane diisocyanate, and tetramethylhexane diisocyanate.

Examples of the alicyclic polyisocyanate include isophorone diisocyanate, and cyclohexylmethane diisocyanate.

Examples of the aromatic diisocyanate include tolylene diisocyanate, diisocyanato diphenyl methane, 1,5-nephthylene diisocyanate, 4,4′-diisocyanato diphenyl, 4,4′-diisocyanato-3,3′-dimethyldiphenyl, 4,4′-diisocyanato-3-methyldiphenyl methane, and 4,4′-diisocyanato-diphenyl ether.

Examples of the aromatic aliphatic diisocyanate include α,α,α′,α′-tetramethylxylene diisocyanate. Examples of the isocyanurate include tris(isocyanatoalkyl)isocyanurate, and tris(isocyanatocycloalkyl)isocyanurate.

As for a blending ratio of the polyisocyanate (PIC) and the active hydrogen group-containing polyester resin (e.g. a hydroxyl group-containing polyester resin) for a reaction, a blending equivalent ratio ([NCO]/[OH]) of isocyanate groups [NCO] in the polyisocyanate (PIC) to hydroxyl groups [OH] in the hydroxyl group-containing polyester resin is typically, preferably 5/1 to 1/1, more preferably 4/1 to 1.2/1, and even more preferably 3/1 to 1.5/1.

When the ratio of the isocyanate groups [NCO] is greater than 5, low temperature fixing ability of a resulting toner may be insufficient. When the ratio thereof is less than 1, offset resistance of a resulting toner may be insufficient.

An amount of the polyisocyanate (PIC) in the isocyanate group-containing polyester prepolymer (A) is appropriately selected depending on the intended purpose without any limitation, and for example, the amount thereof is preferably 0.5% by mass to 40% by mass, more preferably 1% by mass to 30% by mass, and even more preferably 2% by mass to 20% by mass.

When the amount thereof is less than 0.5% by mass, hot offset resistance of a resulting toner is poor, and it may be difficult to attain both heat resistant storage stability and low temperature fixing ability. When the amount thereof is greater than 40% by mass, low temperature fixing ability of a resulting toner may be poor.

The average number of isocyanate groups per molecule of the isocyanate group-containing polyester prepolymer (A) is preferably 1 or more, more preferably 1.2 to 5, and even more preferably 1.5 to 4.

When the average number of the isocyanate groups is less than 1, a molecular weight of the polyester resin (RMPE) modified with the urea bond generating group may be low, resulting in poor hot offset resistance.

### <Production Method of Toner>

The method for forming a toner by missing and dispersing a first binder resin, a second binder resin, and a releasing agent may be a method in which a mixture containing at least a first binder resin, a second binder resin, and a releasing agent are heated and kneaded by a typical heating kneader, roll kneader, or a monoaxial or multi-axial continuous kneader. Also, usable methods are any methods, including: a method containing dispersing, in a fluid medium, such as an aqueous medium, a mixture of a first binder resin, a second binder resin, and a releasing agent into particles, and aggregating and unifying the dispersed particles; a method containing redissolving, in styrene or vinyl monomers, a first binder resin, a second binder resin, and a releasing agent, and allowing the resultant to polymerize in a non-aqueous solvent; a method containing dissolving, in an appropriate solvent, a mixture of a first binder resin, a second binder resin, and a releasing agent, followed by removing the solvent to granulate; and a method containing dissolving, in an appropriate solvent, a mixture of a first binder resin and a releasing agent, and a reactive second binder resin precursor, dispersing the resultant in an aqueous solvent, such as water to allow the reactive second binder resin precursor to react to give a high molecular weight, and then removing the solvent to granulate.

As listed above, pulverizing and particle size regulating methods, and various chemical toner production methods can be used, but the method for producing toner particles is not limited to the examples listed above.

However, polylactic acid is a hard resin and requires high energy for pulverizing. Therefore, it is preferred that a wet method be used.

Particularly preferred are a method containing dissolving, in an appropriate solvent, a mixture including a first binder resin, a second binder resin, and a releasing agent, and dispersing the resultant in an aqueous solvent such as water, followed by removing the solvent to granulate, and a method containing dissolving, in an appropriate solvent, a mixture of a first binder resin and a releasing agent, and a reactive second binder resin precursor, dissolving the resultant in an aqueous solvent, such as water, allowing the reactive second binder resin precursor to react to give a high molecular weight, and then removing the solvent to granulate.

In the production method above, moreover, it is preferred that resin particles are added to an aqueous medium to control shapes of toner particles (e.g., circularity and particle size distribution), or to stabilize toner base particles formed in the aqueous medium. It is also preferred that the resin particles be added so that a covering ratio of the resin particles on the surface of the toner base particle is in the range of 10% to 50%.

Moreover, the weight average particle diameter of the resin particles is preferably 50 nm to 300 nm, and the BET specific surface area of the toner is preferably 1.5 m²/g to 4.0 m²/g.

When the weight average particle diameter of the resin particles is less than 50 nm, and/or the BET specific surface area of the toner is less than 1.5 m²/g, organic particles remained on the surface of the toner becomes a film, or covers the entire surface of the toner, and therefore the resin particles inhibit adhesion between the binder resin component present inside the toner and fixing paper, which may increase the minimum fixing temperature. When the weight average particle diameter of the resin particles is greater than 300 nm, and/or the BET specific surface area is greater than 4.0 m²/g, the organic particles remained on the surface of the toner may be present being in a projected state, and the resin particles are remained as rough multilayer. Therefore, the resin particles again inhibit adhesion between the binder resin component present inside the toner and fixing paper, which may increase the minimum fixing temperature.

The resin particles contained in the toner of the present invention are not particularly limited as long as they are formed of a resin that can form an aqueous dispersion. The resin of the resin particles may be a thermoplastic resin or a thermoset resin, and examples thereof include a vinyl resin, a polyurethane resin, an epoxy resin, a polyester resin, a polyamide resin, a polyimide resin, a silicone resin, a phenol resin, a melamine resin, a urea resin, an aniline resin, an iomer resin, and a polycarbonate resin. These resin may be used in combination for the resin particles. Among them, preferred are a vinyl resin, a polyurethane resin, an epoxy resin, a polyester resin, and a combination of any of these resins, because an aqueous dispersion of fine spherical resin particles can be easily obtained using any of these resins.

The vinyl resin is a polymer obtained through homopolymerization or copolymerization of vinyl monomers, and examples thereof include a styrene-(meth)acrylic acid ester copolymer, a styrene-butadiene copolymer, a (meth)acrylic acid-acrylic acid ester copolymer, a styrene-acrylonitrile copolymer, a styrene-maleic anhydride copolymer, and a styrene-(meth)acrylic acid copolymer.

### <Other Components>

Other components are appropriately selected depending on the intended purpose without any limitation, and examples thereof include a charge controlling agent, a colorant, and a releasing agent.

### <<Charge Controlling Agent>>

A charge controlling agent can be optionally added to the toner of the present invention to impart an appropriate charging ability to the toner.

A method for adding the charge controlling agent can be any methods, including a method for mixing, kneading and dispersing the charge controlling agent inside the resin, a method for introducing the charge controlling agent into a chemical toner, such as by suspension polymerization, by dispersing or dissolving the charge controlling agent in a solvent or droplets of a monomer, a method for incorporating the charge controlling agent, which is dispersed in water, into particles by aggregation and unifying, and a method for chemically adding the charge controlling agent onto surface of a particle.

The charge controlling agent is appropriately selected depending on the intended purpose without any limitation, and examples thereof include: nigrosine; C2-C16 alkyl group-containing azine dyes (JP-B No. 42-1627); basic dyes, such as C.I. Basic Yellow 2 (C.I. 41000), C.I. Basic Yellow 3, C.I. Basic Red 1 (C.I. 45160), C.I. Basic Red 9 (CI. 42500), C.I. Basic Violet 1 (C.I. 42535), C.I. Basic Violet 3 (C.I. 42555), C.I. Basic Violet 10 (C.I. 45170), C.I. Basic Violet 14 (C.I. 42510), C.I. Basic Blue 1 (C.I. 42025), C.I. Basic Blue 3 (C.I. 51005), C.I. Basic Blue 5 (C.I. 42140), C.I. Basic Blue 7 (C.I. 42595), C.I. Basic Blue 9 (C.I. 52015), C.I. Basic Blue 24 (C.I. 52030), C.I. Basic Blue 25 (C.I. 52025), C.I. Basic Blue 26 (C.I. 44045), C.I. Basic Green 1 (C.I. 42040), C.I. Basic Green 4 (C.I. 42000), and lake pigments of these basic dyes; quaternary ammonium salts such as C.I. Solvent Black 8 (C.I. 26150), benzoylmethylhexadecyl ammonium chloride, and decyltrimethyl chloride; dialkyl tin compounds and dialkyl tin borate compounds of dibutyl or dioctyl; guanidine derivatives; polyamine resins, such as amino group-containing vinyl polymer, and amino group-containing condensation polymer; metal complex of monoazo dyes described in JP-B Nos. 41-20153, 43-27596, 44-6397, and 45-26478; metal (e.g., Zn, Al, Co, Cr, and Fe) complexes of salicylic acid, dialkyl salicylate, naphthoic acid, dicarboxylic acid described in JP-B Nos. 55-42752, and 59-7385; a sulfonated copper phthalocyanine pigment; organic boron salt; fluorine-containing quaternary ammonium salt; and a calixarene compound. For a color toner other than a black toner, use of a charge controlling agent, which may impair an intended color, is naturally avoided. In such case, a metal salt of a salicylic acid derivative, which is in white, is suitably used.

### <<Colorant>>

The colorant can be selected from pigments and dyes known in the art that can produce each color of yellow, magenta, cyan, and black toners, without any limitation. Note that, in the case where the colorant is not used, a resulting toner can be used as a transparent toner.

Examples of the yellow pigment include cadmium yellow, mineral fast yellow, nickel titanium yellow, naples yellow, naphthol yellow S, Hansa yellow G, Hansa yellow 10G, benzidine yellow GR, quinoline yellow lake, permanent yellow NCG, and tartrazine lake.

Examples of the orange pigment include molybdenum orange, permanent orange GTR, pyrazolone orange, Vulcan orange, indanthrene brilliant orange RK, benzidine orange G, and indanthrene brilliant orange GK.

Examples of the red pigment include iron red, cadmium red, permanent red 4R, lithol red, pyrazolone red, watching red calcium salt, lake red D, brilliant carmine 6B, eosin lake, rhodamine lake B, alizarin lake, and brilliant carmine 3B.

Examples of the violet pigment include fast violet B, and methyl violet lake.

Examples of the blue pigment include cobalt blue, alkali blue, Victoria blue lake, phthalocyanine blue, metal-free phthalocyanine blue, phthalocyanine blue partial chloride, fast sky blue, and indanthrene blue BC.

Examples of the green pigment include chrome green, chromium oxide, pigment green B, and malachite green lake.

Examples of the black pigment include carbon black, oil furnace black, channel black, lamp black, acetylene black, azine dye such as aniline black, metal salt azo dye, metal oxide, and composite metal oxide.

These may be used alone or in combination.

### <<Releasing Agent>>

The releasing agent is not particularly limited, and any of those known in the art. Particularly, carnauba wax free from free fatty acid, polyethylene wax, montan wax, and oxidized rice wax may be used alone or in combination.

As for the carnauba wax, those of microcrystalline are preferred, and those having an acid value of 5 or lower, having particle diameter of 1 μm or smaller as dispersed in a toner binder are preferable. The montan wax generally denotes montan wax purified with mineral. Similarly to the carnauba wax, it is preferred that the montan wax be microcrystalline, and have an acid value of 5 to 14. The oxidized rice wax is rice bran wax which has been oxidized with air, and the acid value thereof is preferably 10 to 30. These types of wax are preferable, because they are appropriately finely dispersed in the binder resin of the toner of the present invention, and therefore a resulting toner can be easily provided with excellent offset resistance, transfer properties and durability. These may be used alone or in combination.

As for other releasing agents, any of conventional releasing agents, such as solid silicone wax, higher fatty acid higher alcohol, montan ester wax, polyethylene wax, and polypropylene wax, can be used in combination.

Tg of the releasing agent for use in the toner of the present invention is preferably 70° C. to 90° C. When the Tg thereof is lower than 70° C., heat resistant storage stability of a resulting toner may be insufficient. When the Tg thereof is higher than 90° C., the releasing agent cannot exhibit releasing properties at low temperature, which may impair cold offset resistance and cause attachment of paper to a fixing device. An amount of the releasing agent for use is 1% by mass to 20% by mass, preferably 3% by mass to 10% by mass, relative to the resin component of the toner. When the amount thereof is less than 1% by mass, offset resistance of a resulting toner may be insufficient. When the amount thereof is greater than 20% by mass, transfer properties and durability of a resulting toner may be insufficient.

### (Developer)

The developer contains the toner of the present invention, and may further contain appropriately selected other components, such as a carrier, if necessary. The developer may be either a cone-component developer or two-component developer. However, the two-component developer is preferable in view of improved life span when the developer is used with, for example, a high speed printer that complies with improvements in recent information processing speed.

### <Carrier>

The carrier is appropriately selected depending on the intended purpose without any limitation, but it is preferably a carrier consisting of carrier particles each containing a core and a resin layer covering the core.

The core material is not particularly limited and may be appropriately selected from known ones. Preferable are manganese-strontium (Mn—Sr) materials and manganese-magnesium (Mn—Mg) materials of 50 emu/g to 90 emu/g, and also highly magnetized materials such as iron powder (100 emu/g or more) and magnetite (75 emu/g to 120 emu/g) in view of ensuring appropriate image density. Weak-magnetizable materials such as copper-zinc (Cu—Zn) materials (30 emu/g to 80 emu/g) are also preferred in view of reducing the shock to the photoconductor the toner ears from, which is advantageous for high image quality. These may be used alone or in combination.

As for particle diameters of the cores, the weight average particle diameter of the cores is preferably 10 μm to 200 μm, more preferably 40 μm to 100 μm. When the weight average particle diameter thereof is smaller than 10 μm, an increased amount of fine powder is observed in the carrier particle size distribution, and thus magnetization per particle is lowered, which may cause the carrier to fly. When the weight average particle diameter thereof is greater than 200 μm, the specific surface area is reduced, which may cause the toner to fly. Therefore, a full color image having many solid parts may not be well reproduced particularly in the solid parts.

A material of the resin layer is appropriately selected from resins known in the art depending on the intended purpose without any limitation, and examples thereof include an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, a copolymer of vinylidene fluoride and acrylic monomer, a copolymer of vinylidene fluoride and vinyl fluoride, fluoroterpolymer such as terpolymer of tetrafluoroethylene, vinylidene fluoride and non-fluoride monomer, and silicone resins. These may be used alone or in combination. Among them, a silicone resin is particularly preferable.

The silicone resin is appropriately selected silicone resins known in the art without any limitation, and examples thereof include: a straight silicone resin consisting of organosiloxane bonds; and a silicone resin modified with an alkyd resin, a polyester resin, an epoxy resin, an acrylic resin, or a urethane resin.

As for the silicone resin, a commercial product thereof can be used. Examples of the commercial products of a straight silicone resin include KR271, KR255, and KR152 manufactured by Shin-Etsu Chemical Co., Ltd.; and SR2400, SR2406, and SR2410 manufactured by Dow Corning Toray Co., Ltd.

As for the modified silicone resin, a commercial product thereof can be used, and examples of such commercial products include: KR206 (alkyd modified), KR5208 (acryl modified), ES1001N (epoxy modified), KR305 (urethane modified) manufactured by Shin-Etsu Chemical Co., Ltd.; and SR2115 (epoxy modified), and SR2110 (alkyd modified) manufactured by Dow Corning Toray Co., Ltd.

Note that, the silicone resin may be used alone, but it is also possible that the silicone resin is used in combination with a crosslinking component, a charge controlling component, and the like.

The resin layer may contain, for example, conductive powder, as necessary. Examples of conductive powder include metal powder, carbon black, titanium oxide, tin oxide, and zinc oxide. The average particle diameter of conductive powder is preferably 1 μm or smaller. When the average particle diameter is greater than 1 μm, controlling of the electrical resistance may be difficult.

The resin layer can be formed, for example, by dissolving the silicone resins in a solvent to prepare a coating solution, uniformly applying the coating solution to the surface of core material by known coating processes, then drying and baking. Examples of the coating method include dipping, spraying, and brush coating.

The solvent is appropriately selected depending on the intended purpose without any limitation, and examples thereof include toluene, xylene, methyl ethyl ketone, methyl isobutyl ketone, cellosolve, and butyl acetate.

The baking is not particularly limited and may be carried out through external or internal heating. Examples of the baking processes include those by use of fixed electric furnaces, flowing electric furnaces, rotary electric furnaces, burner furnaces, or microwave.

An amount of the resin layer in the carrier is preferably 0.01% by mass to 5.0% by mass. When the amount of the resin layer is less than 0.01% by mass, the resin layer may be formed nonuniformly on the surface of the core. When the amount thereof is more than 5.0% by mass, the resin layer may become excessively thick to cause granulation between carriers, and carrier particles may be formed nonuniformly.

In the case where the developer is a two-component developer, an amount of the carrier in the two-component developer is appropriately selected depending on the intended purpose without any limitation, and for example, the amount thereof is preferably 90% by mass to 98% by mass, more preferably 93% by mass to 97% by mass.

As for a mixing ratio between the toner and carrier in the two-component developer, typically, an amount of the toner is preferably 1 part by mass to 10.0 parts by mass relative to 100 parts by mass of the carrier.

### EXAMPLES

The present invention will be more specifically explained through Examples and Comparative Examples hereinafter, but Examples shall not be construed as to limit the scope of the present invention.

### <Measurement Methods for Properties of Components Used in Examples and Comparative Examples>

### <<Measurement of Molecular Weight>>

The number average molecular weight Mn and weight average molecular weight Mw were measured through gel permeation chromatography (GPC) using as a standard a calibration curve prepared with polystyrene samples each having a known molecular weight. The device and conditions used for the measurement were as follows:

Apparatus: GPC (product of TOSOH CORPORATION)

Detector: RI (differential refractometer)

Measuring temperature: 40° C.

Mobile phase: tetrahydrofuran

Flow rate: 0.45 mL/min.

### <<Measurement of Glass Transition Temperature (Tg) of First Binder Resin>>

A readily sealable aluminum pan charged with 5 mg to 10 mg of a sample was placed in the following device and subjected to the following measuring flow:

Device: DSC (Q2000, product of TA Instruments)

1st Heating: heating from 30° C. to 220° C. at a heating rate of 5° C./min., and after reaching 220° C., the temperature was maintained for 1 minute

Cooling: quenching to −60° C. without temperature control, and after reaching −60° C., the temperature was maintained for 1 minute

2nd Heating: heating from −60° C. to 180° C. at a heating rate of 5° C./min.

The glass transition temperature of the first binder resin was determined and evaluated by a mid point method based on a method described in ASTM D3418/82 using a thermogram of 2nd Heating. The glass transition temperature appeared on the lower temperature side was determined as Tg1, and the glass transition temperature appeared on the higher temperature side was determined as Tg2.

Differences between base lines for two grass transition temperature in the thermogram for 2nd Heating were respectively identified as h1 and h2. “h1” and “h2” were each determined from a difference between an onset point of the lower temperature side and an endset point of the higher temperature side for each glass transition temperature, and a ratio h1/h2 was calculated.

### <<Measurement of Average Particle Diameter of Regions Having Large Phase Difference in Tapping AFM Phase Image of First Binder Resin>>

A block of the binder resin was cut under the following conditions with an ultramicrotome ULTRACUT UCT (product of Leica) and the first binder resin in the cut piece was observed:

Cutting thickness: 60 nm

Cutting speed: 0.4 mm/sec

Diamond knife (Ultra Sonic 35°) used

The observation was performed by means of an atomic force microscope (AFM) MFP-3D (manufactured by Asylum Technology Co., Ltd.) under the following conditions:

Cantilever: OMCL-AC240TS-C3

Target amplitude: 0.5 V

Target percent: −5%

Amplitude set point: 315 mV

Scan rate: 1 Hz

Scan points: 256×256

Scan angle: 0

The obtained tapping mode AFM phase image was binarized using an image editing software Adobe Photoshop CS (of Adobe Systems Inc.), and 30 dispersed diameters of the first phase difference regions (e.g., soft and low Tg units) corresponding to parts having large phase differences were selected from those having the largest diameters, and the average value of the maximum Feret diameters thereof was calculated as the average diameter.

### Production Example 1

### Synthesis of First Binder Resin 1

A 300-mL reaction vessel equipped with a condenser, a stirrer and a nitrogen-introducing tube was charged with an alcohol component and acid components at a proportion (parts by mass) shown in Table 1 so that the total mass of the reagents became 250 g. In addition, titanium tetraisopropoxide (1,000 ppm relative to the resin components) was also added to the reaction vessel as a polymerizing catalyst. Under nitrogen flow, the resultant mixture was heated to 200° C. for about 4 hours and then heated to 230° C. for 2 hours, to thereby perform the reaction until no flow component was formed. Thereafter, the resultant was further reacted for 5 hours under the reduced pressure of 10 mmHg to 15 mmHg, to thereby obtain Initiator 1. The molecular weight and glass transition temperature of Initiator 1 are presented in Table 2.

Next, an autoclave reaction vessel equipped with a thermometer and a stirrer was charged with Initiator 1, followed by adding L-lactide and D-lactide at the ratio as presented in Table 2. In addition, titanium terephthalate was added to the resultant mixture in such an amount that the final concentration thereof became 1% by mass. After the autoclave reaction vessel had been purged with nitrogen, the mixture was allowed to polymerize at 160° C. for 6 hours to synthesize First Binder Resin 1. The number average molecular weight Mn, weight average molecular weight Mw, glass transition temperature Tg1 and Tg2, and ratio h1/h2 of First Binder Resin 1 are presented in Table 3.

### Production Example 2

### Synthesis of First Binder Resin 2

Initiator 2 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 2 are presented in Table 2.

First Binder Resin 2 was synthesized in the same manner as in Production Example 1, provided that Initiator 1 was replaced with Initiator 2. The number average molecular weight Mn, weight average molecular weight Mw, glass transition temperature Tg1 and Tg2, and ratio h1/h2 of First Binder Resin 2 are presented in Table 3.

### Production Example 3

### Synthesis of First Binder Resin 3

Initiator 3 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 3 are presented in Table 2.

Next, First Binder Resin 3 was synthesized in the same manner as in Production Example 1, provided that Initiator 3 was used and L-lactide and D-lactide were changed as depicted in Table 2. The number average molecular weight Mn, weight average molecular weight Mw, glass transition temperature Tg1 and Tg2, and ratio h1/h2 of First Binder Resin 3 are presented in Table 3.

### Production Example 4

### Synthesis of First Binder Resin 4

Initiator 4 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 4 are presented in Table 2.

Next, First Binder Resin 4 was synthesized in the same manner as in Production Example 1, provided that Initiator 4 was used and L-lactide and D-lactide were changed as depicted in Table 2. The number average molecular weight Mn, weight average molecular weight Mw, glass transition temperature Tg1 and Tg2, and ratio h1/h2 of First Binder Resin 4 are presented in Table 3.

### Production Example 5

### Synthesis of First Binder Resin 5

Initiator 5 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 5 are presented in Table 2.

Next, First Binder Resin 5 was synthesized in the same manner as in Production Example 1, provided that Initiator 5 was used and L-lactide and D-lactide were changed as depicted in Table 2. The number average molecular weight Mn, weight average molecular weight Mw, glass transition temperature Tg1 and Tg2, and ratio h1/h2 of First Binder Resin 5 are presented in Table 3.

### Production Example 6

### Synthesis of First Binder Resin 6

Initiator 6 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 6 are presented in Table 2.

Next, First Binder Resin 6 was synthesized in the same manner as in Production Example 1, provided that Initiator 6 was used and L-lactide and D-lactide were changed as depicted in Table 2. The number average molecular weight Mn, weight average molecular weight Mw, glass transition temperature Tg1 and Tg2, and ratio h1/h2 of First Binder Resin 6 are presented in Table 3.

### Production Example 7

### Synthesis of First Binder Resin 7

Initiator 7 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 7 are presented in Table 2.

Next, First Binder Resin 7 was synthesized in the same manner as in Production Example 1, provided that Initiator 7 was used and L-lactide and D-lactide were changed as depicted in Table 2. The number average molecular weight Mn, weight average molecular weight Mw, glass transition temperature Tg1 and Tg2, and ratio h1/h2 of First Binder Resin 7 are presented in Table 3.

### Production Example 8

### Synthesis of First Binder Resin 8

Initiator 8 was obtained in the same manner as in Production Example 1, provided that the formulating amounts of the alcohol component and acid component of Initiator 1 were respectively changed as presented in Table 1.

The number average molecular weight Mn and glass transition temperature Tg of Initiator 8 are presented in Table 2.

Next, First Binder Resin 8 was synthesized in the same manner as in Production Example 1, provided that Initiator 8 was used and L-lactide and D-lactide were changed as depicted in Table 2. The number average molecular weight Mn, weight average molecular weight Mw, glass transition temperature Tg1 and Tg2, and ratio h1/h2 of First Binder Resin 8 are presented in Table 3.

### Production Example 9

### Synthesis of First Binder Resin 9

Initiator 9 was obtained in the same manner as in Production Example 1, provided that the types and formulating amounts of the alcohol component and acid component of Initiator 1 were respectively changed as presented in Table 1.

The number average molecular weight Mn and glass transition temperature Tg of Initiator 9 are presented in Table 2.

Next, First Binder Resin 9 was synthesized in the same manner as in Production Example 1, provided that Initiator 9 was used and L-lactide and D-lactide were changed as depicted in Table 2. The number average molecular weight Mn, weight average molecular weight Mw, glass transition temperature Tg1 and Tg2, and ratio h1/h2 of First Binder Resin 9 are presented in Table 3.

### Production Example 10

### Synthesis of First Binder Resin 10

Initiator 10 was obtained in the same manner as in Production Example 1, provided that the types and formulating amounts of the alcohol component and acid component of Initiator 1 were respectively changed as presented in Table 1.

The number average molecular weight Mn and glass transition temperature Tg of Initiator 10 are presented in Table 2.

Next, First Binder Resin 10 was synthesized in the same manner as in Production Example 1, provided that Initiator 10 was used and L-lactide and D-lactide were changed as depicted in Table 2. The number average molecular weight Mn, weight average molecular weight Mw, glass transition temperature Tg1 and Tg2, and ratio h1/h2 of First Binder Resin 10 are presented in Table 3.

### Production Example 11

### Synthesis of First Binder Resin 11

An autoclave reaction vessel equipped with a thermometer and a stirrer was charged with polyester polyol (Desmophen 1200, of Sumika Bayer Urethane Co., Ltd., number average molecular weight: about 1,000, hydroxyl value: 165 mgKOH/g) as an initiator, followed by adding L-lactide and D-lactide at the ratio as presented in Table 2. In addition, titanium terephthalate was added to the resultant mixture in such an amount that the final concentration thereof became 1% by mass. After the autoclave reaction vessel had been purged with nitrogen, the mixture was allowed to polymerize at 160° C. for 6 hours to synthesize First Binder Resin 11. The number average molecular weight Mn, weight average molecular weight Mw, glass transition temperature (only one glass transition point was observed), and ratio h1/h2 of First Binder Resin 11 are presented in Table 3.

### Production Example 12

### Synthesis of First Binder Resin 12

An autoclave reaction vessel equipped with a thermometer and a stirrer was charged with lauryl alcohol (of Sigma-Aldrich Japan) as an initiator, followed by adding L-lactide and D-lactide at the ratio as presented in Table 2. In addition, titanium terephthalate was added to the resultant mixture in such an amount that the final concentration thereof became 1% by mass. After the autoclave reaction vessel had been purged with nitrogen, the mixture was allowed to polymerize at 160° C. for 6 hours to synthesize First Binder Resin 12. The number average molecular weight Mn, weight average molecular weight Mw, glass transition temperature (only one glass transition point was observed), and ratio h1/h2 of First Binder Resin 12 are presented in Table 3.

### Production Example 13 to 22

### Synthesis of First Binder Resins 13 to 22

Initiators 11 to 20 were each obtained in the same manner as in Production Example 1, provided that the types and formulating amounts of the alcohol component and acid component of Initiator 1 were respectively changed as presented in Table 1.

The number average molecular weight Mn and glass transition temperature Tg of each of Initiators 11 to 20 are presented in Table 2.

Next, First Binder Resins 13 to 22 were each synthesized in the same manner as in Production Example 1, provided that Initiators 11 to 20 were used and L-lactide and D-lactide were changed as depicted in Table 2. The number average molecular weight Mn, weight average molecular weight Mw, glass transition temperature Tg1 and Tg2, and ratio h1/h2 of each of First Binder Resins 13 to 22 are presented in Table 3.

Phase images of Fist Binder Resins 1 to 22 as obtained by tapping mode AFM were observed. As a result, it was observed that First Binder Resins 1 to 10 and 13 to 22 each had a structure where the first phase difference regions corresponding to parts having large phase differences were dispersed in the second phase difference region corresponding to parts having small phase differences. The average diameter of the phase difference regions (the first phase difference regions) corresponding to parts having large phase differences is presented in Table 3. On the other hand, a structure where the first phase difference regions corresponding to parts having large phase differences were dispersed in the second phase difference region corresponding to parts having small phase differences was not observed in Binder Resins 11 to 12, and the phase images thereof were uniform without any contrast on the whole. The phase image of the First Binder Resin 1 by tapping mode AFM is presented in FIG. 2, and the binarized image obtained by binarizing using an intermediate value, as a threshold, of the maximum phase difference value and the minimum phase difference value of the phase image of FIG. 2 is presented in FIG. 3.

TABLE 1

| | Alcohol component (parts by mass) | | | Acid component (parts by mass) | | |
|---|---|---|---|---|---|---|
| | 3-methyl-1, | | | | | trimellitic |
| | 5-pentane | 1,3-propane | neopentyl | dimethyl | dimethyl | acid |
| Initiator | diol | diol | glycol | adipate | terephthalate | anhydride |
| Initiator 1 | 90.0 | 30.0 | 0 | 75.0 | 21.0 | 4.0 |
| Initiator 2 | 102.0 | 18.0 | 0 | 75.0 | 21.0 | 4.0 |
| Initiator 3 | 97.5 | 32.5 | 0 | 75.0 | 21.0 | 4.0 |
| Initiator 4 | 110.5 | 19.5 | 0 | 75.0 | 22.0 | 3.0 |
| Initiator 5 | 39.0 | 91.0 | 0 | 40.0 | 57.0 | 3.0 |
| Initiator 6 | 38.5 | 71.5 | 0 | 60.0 | 37.0 | 3.0 |
| Initiator 7 | 60.0 | 60.0 | 0 | 60.0 | 38.5 | 1.5 |
| Initiator 8 | 65.0 | 65.0 | 0 | 70.0 | 28.5 | 1.5 |
| Initiator 9 | 42.0 | 0 | 78.0 | 75.0 | 23.5 | 1.5 |
| Initiator 10 | 30.0 | 0 | 90.0 | 75.0 | 25.0 | 0 |
| Initiator 11 | 106.6 | 23.4 | 0 | 75 | 21 | 4 |
| Initiator 12 | 96 | 24 | 0 | 70 | 26 | 4 |
| Initiator 13 | 100.1 | 29.9 | 0 | 75 | 22 | 3 |
| Initiator 14 | 91.2 | 28.8 | 0 | 75 | 22 | 3 |
| Initiator 15 | 91 | 39 | 0 | 70 | 27 | 3 |
| Initiator 16 | 78 | 52 | 0 | 75 | 22 | 3 |
| Initiator 17 | 80.3 | 29.7 | 0 | 60 | 38.5 | 1.5 |
| Initiator 18 | 98.8 | 31.2 | 0 | 65 | 33.5 | 1.5 |
| Initiator 19 | 105.3 | 24.7 | 0 | 70 | 28 | 2 |
| Initiator 20 | 107.9 | 22.1 | 0 | 75 | 23 | 2 |

TABLE 2

| | | | | Ratio of | Ratio of | Ratio of | Optical |
|---|---|---|---|---|---|---|---|
| | | Mn of | Tg (° C.) of | initiator | L-lactide | D-lactide | purity |
| | Initiator | initiator | initiator | (mass %) | (mass %) | (mass %) | (%) |
| First binder resin 1 | Initiator 1 | 3,800 | −9 | 30 | 56.0 | 14.0 | 60 |
| First binder resin 2 | Initiator 2 | 4,300 | −10 | 30 | 56.0 | 14.0 | 60 |
| First binder resin 3 | Initiator 3 | 3,800 | −5 | 30 | 59.5 | 10.5 | 70 |
| First binder resin 4 | Initiator 4 | 3,700 | −5 | 40 | 48.0 | 12.0 | 60 |
| First binder resin 5 | Initiator 5 | 3,100 | −13 | 40 | 48.0 | 12.0 | 60 |
| First binder resin 6 | Initiator 6 | 3,600 | −11 | 40 | 48.0 | 12.0 | 60 |
| First binder resin 7 | Initiator 7 | 3,500 | −15 | 40 | 45.0 | 15.0 | 50 |
| First binder resin 8 | Initiator 8 | 2,900 | −8 | 45 | 41.25 | 13.75 | 50 |
| First binder resin 9 | Initiator 9 | 3,200 | −25 | 45 | 41.25 | 13.75 | 50 |
| First binder resin 10 | Initiator 10 | 3,100 | −4 | 45 | 35.75 | 19.25 | 30 |
| First binder resin 11 | Demosphen | 1,000 | −50 | 10 | 49.5 | 40.5 | 10 |
| First binder resin 12 | Lauryl | 186 | — | 5 | 76.0 | 19.0 | 60 |
| | alchohol | | | | | | |
| First binder resin 13 | Initiator 11 | 3,300 | −5 | 30 | 59.5 | 10.5 | 70 |
| First binder resin 14 | Initiator 12 | 3,200 | −12 | 35 | 52 | 13 | 60 |
| First binder resin 15 | Initiator 13 | 4,100 | −10 | 26 | 55.5 | 18.5 | 50 |
| First binder resin 16 | Initiator 14 | 4,300 | −11 | 49 | 40.8 | 10.2 | 60 |
| First binder resin 17 | Initiator 15 | 2,900 | −18 | 24 | 57 | 19 | 50 |
| First binder resin 18 | Initiator 16 | 3,100 | −21 | 15 | 72.3 | 12.8 | 70 |
| First binder resin 19 | Initiator 17 | 3,400 | −15 | 51 | 39.2 | 9.8 | 60 |
| First binder resin 20 | Initiator 18 | 4,500 | −8 | 60 | 28 | 12 | 40 |
| First binder resin 21 | Initiator 19 | 5,100 | −6 | 30 | 56 | 14 | 60 |
| First binder resin 22 | Initiator 20 | 6,400 | −9 | 30 | 59.5 | 10.5 | 70 |

TABLE 3

| | Number | | | | | Average diameter of |
|---|---|---|---|---|---|---|
| | average | Weight average | | | | first phase difference |
| | molecular | molecular | Tg1 | Tg2 | | image in tapping mode |
| | weight Mn | weight Mw | (° C.) | (° C.) | Ratio h1/h2 | AFM phase image (nm) |
| First binder resin 1 | 18,000 | 35,000 | 3 | 37 | 0.6 | 75 |
| First binder resin 2 | 21,000 | 42,000 | 8 | 39 | 0.8 | 55 |
| First binder resin 3 | 19,000 | 41,000 | −2 | 39 | 0.2 | 45 |
| First binder resin 4 | 16,000 | 37,000 | 4 | 47 | 0.4 | 70 |
| First binder resin 5 | 18,000 | 38,000 | 6 | 49 | 0.5 | 100 |
| First binder resin 6 | 13,000 | 34,000 | −1 | 39 | 0.8 | 55 |
| First binder resin 7 | 15,000 | 36,000 | 10 | 65 | 0.7 | 75 |
| First binder resin 8 | 12,000 | 29,000 | 12 | 61 | 0.9 | 85 |
| First binder resin 9 | 11,000 | 35,000 | −13 | 36 | 0.9 | 70 |
| First binder resin 10 | 14,000 | 24,000 | −5 | 51 | 0.8 | 30 |
| First binder resin 11 | 19,000 | 33,000 | — | 52 | — | Could not confirm |
| | | | | | | dispersed structure |
| First binder resin 12 | 18,000 | 32,000 | — | 43 | — | Could not confirm |
| | | | | | | dispersed structure |
| First binder resin 13 | 20,000 | 38,000 | −3 | 38 | 1.1 | 45 |
| First binder resin 14 | 19,000 | 41,000 | 5 | 41 | 1.3 | 35 |
| First binder resin 15 | 17,000 | 35,000 | 11 | 40 | 0.5 | 105 |
| First binder resin 16 | 18,000 | 29,000 | −1 | 55 | 0.7 | 120 |
| First binder resin 17 | 16,000 | 31,000 | 7 | 43 | 0.3 | 75 |
| First binder resin 18 | 16,000 | 40,000 | 8 | 58 | 0.5 | 60 |
| First binder resin 19 | 14,000 | 37,000 | −4 | 61 | 0.4 | 65 |
| First binder resin 20 | 16,000 | 33,000 | 12 | 45 | 0.4 | 85 |
| First binder resin 21 | 23,000 | 44,000 | 13 | 59 | 0.9 | 55 |
| First binder resin 22 | 24,000 | 38,000 | 9 | 60 | 0.7 | 70 |

### Production Example 23

### Synthesis of Second Binder Resin Precursor 1

An autoclave equipped with a thermometer, stirrer and nitrogen inlet tube was charged with the acid component and alcohol component each in the amount (parts by mass) as depicted in Table 4. In addition, 0.06 parts by mass of stannous octanoate was added to the mixture. After the autoclave reaction vessel had been purged with nitrogen, the mixture was allowed to polymerize at 160° C. for 8 hours to obtain Intermediate Product 1 of Second Binder Resin Precursor.

Next, a reaction vessel equipped with a cooling tube, stirrer and nitrogen inlet tube was charged with 450 parts by mass of Intermediate Product 1 of Second Binder Resin Precursor, 95 parts by mass of isophorone diisocyanate, and 600 parts by mass of ethyl acetate, and the resulting mixture was allowed to react for 6 hours at 100° C. to thereby synthesize Second Binder Resin Precursor 1. Second Binder Resin Precursor 1 as obtained had a free isocyanate content of 1.21% by mass. The weight average molecular weight Mw, number average molecular weight Mn, and presence of X-ray diffraction peaks (at least three diffraction peaks in the region, 2θ=19° to 25°), which indicates crystallinity, if Second Binder Resin Precursor 1 are depicted in Table 4.

### Production Example 24

### Synthesis of Second Binder Resin Precursor 2

Second Binder Resin Precursor 2 was synthesized in the same manner as in Production Example 23, provided that the types and formulating amounts of the acid component and alcohol component were changed as depicted in Table 4. Second Binder Resin Precursor 2 as obtained had the free isocyanate content of 1.32% by mass. The weight average molecular weight Mw, number average molecular weight Mn, and presence of X-ray diffraction peaks indicating crystallinity of Second Binder Resin Precursor 2 are depicted in Table 4.

### Production Example 25

### Synthesis of Second Binder Resin Precursor 3

Second Binder Resin Precursor 3 was synthesized in the same manner as in Production Example 23, provided that the types and formulating amounts of the acid component and alcohol component were changed as depicted in Table 4. Second Binder Resin Precursor 3 as obtained had the free isocyanate content of 1.42% by mass. The weight average molecular weight Mw, number average molecular weight Mn, and presence of X-ray diffraction peaks indicating crystallinity of Second Binder Resin Precursor 3 are depicted in Table 4.

### Production Example 26

### Synthesis of Second Binder Resin Precursor 4

Second Binder Resin Precursor 4 was synthesized in the same manner as in Production Example 23, provided that the types and formulating amounts of the acid component and alcohol component were changed as depicted in Table 4. The weight average molecular weight Mw, number average molecular weight Mn, and presence of X-ray diffraction peaks indicating crystallinity of Second Binder Resin Precursor 4 are depicted in Table 4.

### Production Example 27

### Synthesis of Second Binder Resin Precursor 5

Second Binder Resin Precursor 5 was synthesized in the same manner as in Production Example 23, provided that the types and formulating amounts of the acid component and alcohol component were changed as depicted in Table 4. The weight average molecular weight Mw, number average molecular weight Mn, and presence of X-ray diffraction peaks indicating crystallinity of Second Binder Resin Precursor 5 are depicted in Table 4.

TABLE 4

| | | | | | Alcoholcomponent (partsbymass) | | | | | | |
|---|---|---|---|---|---|---|---|---|---|---|---|
| | | | | | | | | Bisphenol | | | |
| | | | | | | | | Aethylene | | | Presenceof |
| | Acidcomponent (partsbymass) | | | | | | | oxide | | | X-ray |
| | Fumaric | Adipic | Sebacic | Terephthalic | Ethylene | 1,4-butane | 1,6-hexane | (2 mol) | | | diffraction |
| | acid | acid | acid | acid | glycol | diol | diol | adduct | Mn | Mw | peaks |
| Second | 75 | 5 | 0 | 0 | 5 | 95 | 0 | 0 | 3,800 | 12,000 | Present |
| Binder Resin | | | | | | | | | | | |
| Precursor1 | | | | | | | | | | | |
| Second | 0 | 5 | 75 | 0 | 5 | 0 | 95 | 0 | 3,500 | 15,000 | Present |
| Binder Resin | | | | | | | | | | | |
| Precursor2 | | | | | | | | | | | |
| Second | 40 | 5 | 35 | 0 | 10 | 0 | 90 | 0 | 4,200 | 23,000 | Present |
| Binder Resin | | | | | | | | | | | |
| Precursor3 | | | | | | | | | | | |
| Second | 0 | 20 | 0 | 60 | 10 | 0 | 0 | 90 | 2,200 | 18,000 | Notpresent |
| Binder Resin | | | | | | | | | | | |
| Precursor4 | | | | | | | | | | | |
| Second | 0 | 20 | 0 | 60 | 0 | 50 | 0 | 50 | 2,300 | 17,000 | Notpresent |
| Binder Resin | | | | | | | | | | | |
| Precursor5 | | | | | | | | | | | |

### Example 1

### Production of Toner 1

### <Production of Particle Dispersion Liquid>>

A reaction vessel equipped with a stirring bar and a thermometer was charged with 600 parts by mass of water, 135 parts by mass of styrene, 110 parts by mass of methacrylic acid, 50 parts by mass of butyl acrylate, 13 parts by mass of sodium salt of alkyl allyl sulfosuccinic acid (ELEMINOL JS-2, manufactured by Sanyo Chemical Industries, Ltd.), 2 parts by mass of ammonium persulfate, and the mixture was stirred for 20 minutes at 400 rpm/min to thereby obtain a white emulsion. The emulsion was then heated until the temperature in the system reached 75° C., followed by reacting for 6 hours. Further 30 parts by mass of 1% ammonium persulfate aqueous solution was added, and the resultant was aged for 6 hours at 75° C., to thereby obtain Particle Dispersion Liquid, which was an aqueous dispersion liquid of a vinyl resin (styrene-methacrylic acid-butyl methacrylate-alkylallylsulfosuccinic acid sodium salt copolymer). The volume average particle diameter of Particle Dispersion Liquid as measured by an electrophoretic light scattering photometer (ELS-800, manufactured by OTSUKA ELECTRIC CO., LTD.) was 0.09 p.m. Part of Particle Dispersion Liquid was dried to isolate a resin component, and the glass transition temperature of the resin component as measured by a flow tester was 76° C.

### <<Preparation of Aqueous Medium>>

With 300 parts by mass of ion-exchanged water, 300 parts by mass of Particle Dispersion Liquid and 0.2 parts by mass of sodium dodecylbenzene sulfonate were mixed, and the resulting mixture was stirred to be dissolved homogeneously, to thereby prepare an aqueous medium phase, which was used as Aqueous Medium.

### <<Preparation of Master Batch>>

Using HENSCHEL MIXER (manufactured by Nippon Cole & Engineering Co., Ltd.), 1,000 parts by mass of water, 530 parts by mass of carbon black (Printex35, manufactured by Evonik Degussa Japan Co., Ltd., DBP oil absorption amount: 42 mL/100 g, pH: 9.5), and 1,200 parts by mass of First Binder Resin 1 were mixed.

The resulting mixture was kneaded by means of a two roll mill for 30 minutes at 150° C. The resulting kneaded product was rolled out and cooled, followed by pulverizing by a pulverizer (manufactured by Hosokawa Micron Corporation), to thereby obtain Master Batch 1. Master Batches 2 to 22 were prepared in the same manner to the above, provided that First Binder Resin 1 was replaced with First Binder Resins 2 to 22, respectively.

### <<Synthesis of Ketimine Compound>>

A reaction vessel equipped with a stirring bar and a thermometer was charged with 30 parts by mass of isophorone diamine, and 70 parts by mass of methyl ethyl ketone, and the mixture was allowed to react for 5 hours at 50° C., to thereby synthesis a ketimine compound. The obtained ketimine compound had an amine value of 423 mgKOH/g.

### <<Production of Toner Base Particles>>

A reaction vessel was charged with First Binder Resin 1 and Second Binder Resin Precursor 1 both in amounts (parts by mass) depicted in Table 5, and 80 parts by mass of ethyl acetate, and the mixture was stirred to thereby prepare Resin Solution 1.

Next, to Resin Solution 1, carnauba wax (molecular weight: 1,800, acid value: 2.7 mgKOH/g, penetration degree: 1.7 mm (40° C.)) and Master Batch 1 were added in the amounts (parts by mass) depicted in Table 5, and the mixture was dispersed by means of a bead mill (ULTRA VISCOMILL, manufactured by AIMEX CO., Ltd.) under the conditions: a liquid feed rate of 1 kg/hr, disc circumferential velocity of 6 m/s, 0.5 mm-zirconia beads packed to 80% by volume, and 3 passes. To the resultant, the ketimine compound was added in the amount (parts by mass) depicted in Table 5, and dissolved, to thereby prepare Toner Material Solution 1.

Next, a vessel was charged with the aqueous medium in the amount depicted in Table 5. While stirring the aqueous medium by means of TK Homomixer (manufactured by PRIMIX Corporation) at 12,000 rpm, 100 parts by mass of Toner Material Solution 1 was added, and the resultant was mixed for 10 minutes to thereby obtain an emulsified slurry. Further, a flask equipped with a stirrer and thermometer was charged with 100 parts by mass of the emulsified slurry, and the solvent therein was removed at 30° C. for 10 hours with stirring at a stirring rim speed of 20 m/min, to thereby obtain Dispersion Slurry 1.

Next, 100 parts by mass of Dispersion Slurry 1 was subjected to filtration under reduced pressure, and to the filtration cake as obtained, 100 parts by mass of ion-exchanged water was added. The resultant was stirred at 12,000 rpm for 10 minutes by means of TK Homomixer, and then subjected to filtration. To the filtration cake as obtained, 300 parts by mass of ion-exchanged water was added, and the resultant was mixed at 12,000 rpm for 10 minutes by means of TK Homomixer, followed by filtration, and this process was carried out twice in total. To the filtration cake as obtained, 20 parts by mass of a 10% by mass sodium hydroxide aqueous solution was added, and the resultant was mixed at 12,000 rpm for 30 minutes by means of TK Homomixer, followed by filtration under reduced pressure. To the obtained filtration cake as obtained, 300 parts by mass of ion-exchanged water was added, and resultant was mixed at 12,000 rpm for 10 minutes by means of TK Homomixer, followed by filtration. To the filtration cake as obtained, 300 parts by mass of ion-exchanged water was added, the resultant was mixed at 12,000 rpm for 10 minutes by means of TK Homomixer, followed by filtration, and this process was carried out twice in total. To the filtration cake as obtained, 20 parts by mass of 10% by mass hydrochloric acid was added, and the resulting mixture was mixed at 12,000 rpm for 10 minutes by means of TK Homomixer. Thereafter, to the resultant, a 5% methanol solution of a fluoro quaternary ammonium salt compound Futergent F-310 (manufactured by NEOS COMPANY LIMITED) was added in a form of a 5% methanol solution so that the fluoro quaternary ammonium salt was 0.1 parts by mass relative to 100 parts by mass of the solids of the toner, and the stirred for 10 minutes, followed by filtration. To the filtration cake as obtained, 300 parts by mass of ion-exchanged water was added, the resultant was mixed at 12,000 rpm for 10 minutes by means of TK Homomixer, followed by filtration, and this process was carried out twice in total, to thereby obtain a filtration cake. The filtration cake as obtained was dried at 40° C. for 36 hours by means of an air-circulating drier, and then was passed through a sieve with a mesh size of 75 μm, to thereby produce Toner Base Particles 1.

### <<Addition of External Additive>>

Using HENSCHEL MIXER (manufactured by Nippon Cole & Engineering Co., Ltd.), 100 parts by mass of Toner Base Particles 1 and 1.0 part by mass of hydrophobic silica (H2000, manufactured by Clariant Japan) serving as external additive were mixed at rim speed of 30 m/sec for 30 seconds, and were rested for 1 minute. This process was carried out for 5 cycles. The resultant was passed through a mesh having an opening size of 35 μm, to thereby produce Toner 1.

### Examples 2 to 25

### Productions of Toners 2 to 25

Toners 2 to 25 of Examples 2 to 25 were produced in the same manner as in Example 1, provided that the first binder resin, second binder resin, master batch and ketimine compound were changed as depicted in Table 5.

### Comparative Examples 1 to 5

### Productions of Toners 26 to 30

Toners 26 to 30 of Comparative Examples 1 to 5 were produced in the same manner as in Example 1, provided that the first binder resin, second binder resin, master batch and ketimine compound were changed as depicted in Table 5.

TABLE 5

| | | | | | | Carnauba | | | Ketimine | Aqueous |
|---|---|---|---|---|---|---|---|---|---|---|
| | | | | | | wax | | | compound | medium |
| | | First binder resin | | Second binder resin | | (parts by | Master batch | | (parts by | (parts by |
| | | (parts by mass) | | (parts by mass) | | mass) | (parts by mass) | | mass) | mass) |
| Ex. 1 | Toner 1 | First binder | 100 | Second binder | 30 | 8 | Master batch 1 | 10 | 3.0 | 150 |
| | | resin 1 | | resin precursor 1 | | | | | | |
| Ex. 2 | Toner 2 | First binder | 100 | Second binder | 30 | 8 | Master batch 2 | 10 | 3.0 | 150 |
| | | resin 2 | | resin precursor 1 | | | | | | |
| Ex. 3 | Toner 3 | First binder | 100 | second binder | 30 | 8 | Master batch 3 | 10 | 3.0 | 150 |
| | | resin 3 | | resin precursor 1 | | | | | | |
| Ex. 4 | Toner 4 | First binder | 100 | Second binder | 30 | 8 | Master batch 4 | 10 | 3.0 | 150 |
| | | resin 4 | | resin precursor 1 | | | | | | |
| Ex. 5 | Toner 5 | First binder | 100 | Second binder | 30 | 8 | Master batch 5 | 10 | 3.0 | 150 |
| | | resin 5 | | resin precursor 1 | | | | | | |
| Ex. 6 | Toner 6 | First binder | 100 | Second binder | 30 | 8 | Master batch 6 | 10 | 3.0 | 150 |
| | | resin 6 | | resin precursor 2 | | | | | | |
| Ex. 7 | Toner 7 | First binder | 100 | Second binder | 30 | 8 | Master batch 7 | 10 | 3.0 | 150 |
| | | resin 7 | | resin precursor 2 | | | | | | |
| Ex. 8 | Toner 8 | First binder | 100 | Second binder | 30 | 8 | Master batch 8 | 10 | 3.0 | 150 |
| | | resin 8 | | resin precursor 2 | | | | | | |
| Ex. 9 | Toner 9 | First binder | 100 | Second binder | 30 | 8 | Master batch 9 | 10 | 3.0 | 150 |
| | | resin 9 | | resin precursor 2 | | | | | | |
| Ex. 10 | Toner 10 | First binder | 100 | Second binder | 30 | 8 | Master batch 10 | 10 | 3.0 | 150 |
| | | resin 10 | | resin precursor 2 | | | | | | |
| Ex. 11 | Toner 11 | First binder | 100 | Second binder | 30 | 8 | Master batch 1 | 10 | 3.0 | 150 |
| | | resin 1 | | resin precursor 3 | | | | | | |
| Ex. 12 | Toner 12 | First binder | 100 | Second binder | 35 | 8 | Master batch 2 | 10 | 3.5 | 150 |
| | | resin 2 | | resin precursor 3 | | | | | | |
| Ex. 13 | Toner 13 | First binder | 100 | Second binder | 40 | 8 | Master batch 3 | 10 | 3.5 | 150 |
| | | resin 3 | | resin precursor 3 | | | | | | |
| Ex. 14 | Toner14 | First binder | 100 | Second binder | 25 | 8 | Master batch 4 | 10 | 2.5 | 150 |
| | | resin 4 | | resin precursor 3 | | | | | | |
| Ex. 15 | Toner 15 | First binder | 100 | Second binder | 20 | 8 | Master batch 5 | 10 | 2.5 | 150 |
| | | resin 5 | | resin precursor 3 | | | | | | |
| Ex. 16 | Toner 16 | First binder | 100 | Second binder | 30 | 8 | Master batch 13 | 10 | 3.5 | 150 |
| | | resin 13 | | resin precursor 1 | | | | | | |
| Ex. 17 | Toner 17 | First binder | 100 | Second binder | 30 | 8 | Master batch 14 | 10 | 3.5 | 150 |
| | | resin 14 | | resin precursor 1 | | | | | | |
| Ex. 18 | Toner 18 | First binder | 100 | Second binder | 35 | 8 | Master batch 15 | 10 | 3.5 | 150 |
| | | resin 15 | | resin precursor 1 | | | | | | |
| Ex. 19 | Toner 19 | First binder | 100 | Second binder | 35 | 8 | Master batch 16 | 10 | 3.5 | 150 |
| | | resin 16 | | resin precursor 1 | | | | | | |
| Ex. 20 | Toner 20 | First binder | 100 | Second binder | 30 | 8 | Master batch 17 | 10 | 3.5 | 150 |
| | | resin 17 | | resin precursor 3 | | | | | | |
| Ex. 21 | Toner 21 | First binder | 100 | Second binder | 30 | 8 | Master batch 18 | 10 | 3.5 | 150 |
| | | resin 18 | | resin precursor 3 | | | | | | |
| Ex. 22 | Toner 22 | First binder | 100 | Second binder | 30 | 8 | Master batch 19 | 10 | 3.5 | 150 |
| | | resin 19 | | resin precursor 3 | | | | | | |
| Ex. 23 | Toner 23 | First binder | 100 | Second binder | 30 | 8 | Master batch 20 | 10 | 3.5 | 150 |
| | | resin 20 | | resin precursor 3 | | | | | | |
| Ex. 24 | Toner 24 | First binder | 100 | Second binder | 30 | 8 | Master batch 21 | 10 | 3.5 | 150 |
| | | resin 21 | | resin precursor 3 | | | | | | |
| Ex. 25 | Toner 25 | First binder | 100 | Second binder | 30 | 8 | Master batch 22 | 10 | 3.5 | 150 |
| | | resin 22 | | resin precursor 3 | | | | | | |
| Comp. | Toner 26 | First binder | 100 | Second binder | 30 | 8 | Master batch 11 | 10 | 3.5 | 150 |
| Ex. 1 | | resin 11 | | resin precursor 1 | | | | | | |
| Comp. | Toner 27 | First binder | 100 | Second binder | 35 | 8 | Master batch 12 | 10 | 3.5 | 150 |
| Ex. 2 | | resin 12 | | resin precursor 1 | | | | | | |
| Comp. | Toner 28 | First binder | 100 | Second binder | 30 | 8 | Master batch 1 | 10 | 3.5 | 150 |
| Ex. 3 | | resin 1 | | resin precursor 4 | | | | | | |
| Comp. | Toner 29 | First binder | 100 | Second binder | 35 | 8 | Master batch 1 | 10 | 3.5 | 150 |
| Ex. 4 | | resin 1 | | resin precursor 5 | | | | | | |
| Comp. | Toner 30 | First binder | 100 | — | — | 8 | Master batch 1 | 10 | 0.0 | 150 |
| Ex. 5 | | resin 1 | | | | | | | | |

### <Production of Carrier>

To 100 parts by mass of toluene, 100 parts by mass of a silicone resin (SR2411, manufactured by Dow Corning Toray Co., Ltd.), 5 parts by mass of γ-(2-aminomethyl)aminopropyltrimethoxysilane, and 10 parts by mass of carbon black were added, and the resulting mixture was dispersed by means of Homomixer for 20 minutes, to thereby prepare a coat layer forming liquid. The coat layer forming liquid was applied to 1,000 parts by mass of spherical magnetite having particle diameters of 50 μm to coat surfaces thereof by means of a fluidized bed coating device, to thereby prepare a magnetic carrier.

### <Production of Developer>

By means of a ball mill, 5 parts by mass of each of toners obtained in Examples 1 to 25 and Comparative Examples 1 to 5, and 95 parts by mass of the carrier were mixed, to thereby prepare two component developers of Examples 1 to 25 and Comparative Examples 1 to 5.

### <Evaluation Method>

Each developer as obtained was evaluated in terms of low temperature fixing ability, heat resistant storage stability, image density, transfer unevenness, and fine line reproducibility in the following manners. The results are presented in Table 6.

### <<Low Temperature Fixing Ability>>

A photocopier MF-200 manufactured by Ricoh Company Limited using a Teflon (registered trade mark) roller as a fixing roller was used. In this device, each developer was set, and a solid image was formed respectively on transfer paper including plain paper (Type 6200, manufactured by Ricoh Company Limited) and thick paper (photocopy printing paper <135>, manufactured by Ricoh Business Expert, Ltd.), to give a toner deposition amount of 0.85±0.1 mg/cm², and the low temperature fixing ability was evaluated. A fixing test was performed with varying the temperature of the fixing roller to measure the minimum fixing temperature on the thick paper, and the results were evaluated based on the following evaluation criteria. Note that, the minimum fixing temperature was determined with the temperature of the fixing roller at which the residual rate of the image density became 70% or higher after scraping the obtained fixed image.

### —Evaluation Criteria—

A: The minimum fixing temperature was lower than 120° C.

B: The minimum fixing temperature was 120° C. or higher but lower than 130° C.

C: The minimum fixing temperature was 130° C. or higher but lower than 140° C.

D: The minimum fixing temperature was 140° C. or higher.

In the evaluation criteria above, C or higher is practically usable.

### <<Heat Resistant Storage Stability (Penetration Degree)>>

A 50 mL-glass container was charged with each toner, and was left in a thermostat of 50° C. for 24 hours. The toner was then cooled to 24° C., and was subjected to measurement of a penetration degree (mm) by a penetration degree test (JIS K2235-1991). The results were evaluated based on the following evaluation criteria. Note that, the larger the value of the penetration degree, more excellent heat resistant storage stability is. When the value thereof is less than 5 mm, it is likely that a problem may occur on practical use.

### —Evaluation Criteria—

A: Penetration degree of 25 mm or greater

B: Penetration degree of 15 mm or greater but less than 25 mm

C: Penetration degree of 5 mm or more but less than 15 mm

D: Penetration degree of less than 5 mm In the evaluation criteria above, C or higher is practically usable.

### <<Image Density>>

An solid image was formed on copying paper (TYPE 6000<70W>, manufactured by Ricoh Company Limited) by means of a tandem-type color electrophotographic device (IMAGIO NEO 450, manufactured by Ricoh Company Limited) to give a deposition amount of each developer of 1.00±0.05 mg/cm², where a surface temperature of a fixing roller was set at 160±2° C. An image density of a solid image obtained at 30,000th output of continuous printing was measured at 6 random points by means of a spectrometer (938 SPECTRODENSITOMETER, manufactured by X-Rite Co., Ltd.), and the results were evaluated based on the following evaluation criteria. Note that, the image density value was the average value of image density values measured at the 6 points.

### —Evaluation Criteria—

A: 2.0 or greater

B: 1.70 or greater but less than 2.0

C: less than 1.70

In the evaluation criteria above, B or higher is practically usable.

### <<Transfer Unevenness>>

An image density obtained in the same manner as in the evaluation method for the image density was visually observed where or not there were image unevenness (transfer unevenness) due to transfer failures, and the results were evaluated based on the following evaluation.

### —Evaluation Criteria—

A: Density unevenness was not observed at all.

B: Density unevenness was hardly observed.

C: Density unevenness was observed, but it was a level that was not problematic on practical use.

D: Density unevenness was observed and it was a level that was problematic on practical use.

E: Density unevenness was observed in many areas and it was a level that could not be applied for practical use.

### <<Fine Line Reproducibility>>

By means of a tandem-type color electrophotographic device (IMAGIO NEO 450, manufactured by Ricoh Company Limited), a one-dot lattice line image with 600 dot/inch and 150 line/inch respectively in main scanning and subscanning directions was output on copying paper (TYPE 6000<70W>, manufactured by Ricoh Company Limited). A line image obtained at 30,000th output of the continuous printing in the aforementioned manner was visually observed whether there was a cut or friction mark with five ranks.

### —Evaluation Criteria—

A: No cut and friction mark of the line image was observed.

B: A cut and friction mark of the line image were hardly observed.

C: A cut or friction mark of the line image was observed, but it was a level that was not problem on practical use.

D: A cut or friction mark of the line image was observed, and it was a level that was problematic on practical use.

E: Many cuts or friction marks of the line image were observed, and it was a level that could not be applied for practical use.

TABLE 6

| | | Low | Heat resistant | | | |
|---|---|---|---|---|---|---|
| | | temperature | storage | Image | Transfer | Fine line |
| | Toner | fixing ability | stability | density | unevenness | reproducibility |
| Ex. 1 | Toner 1 | A | B | A | B | B |
| Ex. 2 | Toner 2 | B | A | B | B | A |
| Ex. 3 | Toner 3 | A | A | A | B | B |
| Ex. 4 | Toner 4 | A | B | B | A | A |
| Ex. 5 | Toner 5 | B | B | A | B | A |
| Ex. 6 | Toner 6 | B | A | A | B | B |
| Ex. 7 | Toner 7 | B | A | A | A | A |
| Ex. 8 | Toner 8 | A | B | A | A | A |
| Ex. 9 | Toner 9 | A | A | B | A | A |
| Ex. 10 | Toner 10 | B | A | B | B | B |
| Ex. 11 | Toner 11 | B | A | A | C | B |
| Ex. 12 | Toner 12 | A | B | A | A | A |
| Ex. 13 | Toner 13 | A | B | B | A | A |
| Ex. 14 | Toner 14 | B | A | B | B | B |
| Ex. 15 | Toner 15 | A | B | B | A | A |
| Ex. 16 | Toner 16 | B | B | A | B | A |
| Ex. 17 | Toner 17 | B | C | B | A | A |
| Ex. 18 | Toner 18 | B | A | A | A | A |
| Ex. 19 | Toner 19 | C | A | A | B | A |
| Ex. 20 | Toner 20 | C | A | A | A | A |
| Ex. 21 | Toner 21 | C | A | B | A | B |
| Ex. 22 | Toner 22 | B | C | B | A | A |
| Ex. 23 | Toner 23 | A | C | C | B | A |
| Ex. 24 | Toner 24 | B | B | A | B | A |
| Ex. 25 | Toner 25 | B | C | B | C | A |
| Comp. | Toner 26 | D | D | C | D | E |
| Ex. 1 | | | | | | |
| Comp. | Toner 27 | C | D | C | E | E |
| Ex. 2 | | | | | | |
| Comp. | Toner 28 | B | B | B | D | D |
| Ex. 3 | | | | | | |
| Comp. | Toner 29 | B | A | B | D | E |
| Ex. 4 | | | | | | |
| Comp. | Toner 30 | B | B | B | D | E |
| Ex. 5 | | | | | | |

It was found from Table 6 that the glass transition temperature Tg1 and Tg2 of the binder resin were observed in certain temperature ranges, and the toners of Examples 1 to 25 produced using a crystalline resin as the second binder resin attained all of excellent low temperature fixing ability, heat resistant storage stability, and image density. Further, these toner each having a structure by which toner spent was hardly caused, the results of the evaluation related to the image quality, such as transfer unevenness and fine line reproducibility, were excellent even after performing continuous printing for a long period.

On the other hand, the toners, in each of which a phase separated small-diameter domain structure was not observed, such as the toners of Comparative Examples 1 and 2, did not show Tg1 in DSC, and did not attain sufficient low temperature fixing ability and heat resistant storage stability. Moreover, in the case where a resin having a noncrystalline structure was used as the second binder resin, such as in the case of the toners of Comparative Examples 3 and 4, or in the case where a crystalline resin was not contained as the second binder resin, such as in the case of the toner of Comparative Example 5, low temperature fixing ability, heat resistant storage stability, and image density were desirable, but toner spent occurred after continuous printing, the results of the transfer unevenness or fine line reproducibility were not desirable, and therefore prints of sufficient image quality were not obtained.

The embodiments of the present invention are, for example, as follows:

<1> A toner, containing:

a first binder resin, and

a second binder resin,

wherein the first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min,

wherein the Tg1 is −20° C. to 20° C., and the Tg2 is 35° C. to 65° C., and

wherein the second binder resin is a crystalline resin.

<2> The toner according to <1>, wherein a ratio h1/h2 is less than 1.0, where h1 is a difference in a heat flow rate between base lines for the Tg1, and h2 is a difference in a heat flow rate between base lines for the Tg2.
<3> The toner according to any of <1> or <2>, wherein a binarized image of a phase image of the first binder resin contains first phase difference regions each formed of first pixels and a second phase difference region formed of second pixels where the first phase difference regions are dispersed in the second phase difference region,

wherein the binarized image of the phase image of the first binder resin is obtained through a process containing: measuring the first binder resin by a tapping mode atomic force microscopy to obtain phase differences at parts of the binder resin; converting the phase differences into image densities of pixels so that the parts having smaller phase differences are dark colored and the parts having greater phase differences are light colored; and mapping the parts to obtain the phase image; and subjecting the phase image to binarization using, as a threshold, an intermediate value between a maximum value and a minimum value of the image densities, so that the image densities of the first pixels are equal to or more than the minimum value but less than the intermediate value and the image densities of the second pixels are equal to or more than the intermediate value but equal to or less than the maximum value, and

wherein the first phase difference regions have the average particle diameter of 100 nm or smaller.

<4> The toner according to any one of <1> to <3>, wherein the second binder resin is polyester that does not contain, in a repeating structure thereof, a constitutional unit formed by dehydration condensation of hydroxycarboxylic acid.
<5> The toner according to any one of <1> to <4>, wherein the second binder resin is formed by dispersing or emulsifying, in an aqueous medium, an active hydrogen group-containing compound and a modified polyester resin reactive with the active hydrogen group-containing compound, and carrying out an elongation or crosslink reaction of the active hydrogen group-containing compound and the modified polyester resin.
<6> The toner according to any one of <1> to <5>, wherein the polyester skeleton A is obtained through ring-opening polymerization of a mixture containing L-lactide and D-lactide.
<7> The toner according to any one of <1> to <6>, wherein the first binder resin is obtained through ring-opening polymerization of lactide using the skeleton B as an initiator, and

wherein the skeleton B has two or more hydroxyl groups.

<8> The toner according to any one of <1> to <7>, wherein a mass ratio of the skeleton B in the first binder resin is 25% by mass to 50% by mass.
<9> The toner according to any one of <1> to <8>, wherein the skeleton B has the number average molecular weight Mn(B) of 3,000 to 5,000.
<10> A developer, containing the toner as defined in any one of <1> to <9>.

This application claims priority to Japanese application No. 2011-267858, filed on Dec. 7, 2011, and incorporated herein by reference.

What is claimed is:

1. A toner, comprising:
a first binder resin, and
a second binder resin,
wherein the first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min,
wherein the Tg1 is −20° C. to 20° C., and the Tg2 is 35° C. to 65° C., and
wherein the second binder resin is a crystalline resin.

2. The toner according to claim 1, wherein a ratio h1/h2 is less than 1.0, where h1 is a difference in a heat flow rate between base lines for the Tg1, and h2 is a difference in a heat flow rate between base lines for the Tg2.

3. The toner according to claim 1, wherein a binarized image of a phase image of the first binder resin contains first phase difference regions each formed of first pixels and a second phase difference region formed of second pixels where the first phase difference regions are dispersed in the second phase difference region,
wherein the binarized image of the phase image of the first binder resin is obtained through a process containing: measuring the first binder resin by a tapping mode atomic force microscopy to obtain phase differences at parts of the binder resin; converting the phase differences into image densities of pixels so that the parts having smaller phase differences are dark colored and the parts having greater phase differences are light colored; and mapping the parts to obtain the phase image; and subjecting the phase image to binarization using, as a threshold, an intermediate value between a maximum value and a minimum value of the image densities, so that the image densities of the first pixels are equal to or more than the minimum value but less than the intermediate value and the image densities of the second pixels are equal to or more than the intermediate value but equal to or less than the maximum value, and
wherein the first phase difference regions have the average particle diameter of 100 nm or smaller.

4. The toner according to claim 1, wherein the second binder resin is polyester that does not contain, in a repeating structure thereof, a constitutional unit formed by dehydration condensation of hydroxycarboxylic acid.

5. The toner according to claim 1, wherein the second binder resin is formed by dispersing or emulsifying, in an aqueous medium, an active hydrogen group-containing compound and a modified polyester resin reactive with the active hydrogen group-containing compound, and carrying out an elongation or crosslink reaction of the active hydrogen group-containing compound and the modified polyester resin.

6. The toner according to claim 1, wherein the polyester skeleton A is obtained through ring-opening polymerization of a mixture containing L-lactide and D-lactide.

7. The toner according to claim 1, wherein the first binder resin is obtained through ring-opening polymerization of lactide using the skeleton B as an initiator, and
wherein the skeleton B has two or more hydroxyl groups.

8. The toner according to claim 1, wherein a mass ratio of the skeleton B in the first binder resin is 25% by mass to 50% by mass.

9. The toner according to claim 1, wherein the skeleton B has the number average molecular weight Mn(B) of 3,000 to 5,000.

10. A developer, comprising:
a toner,
wherein the toner contains:
a first binder resin, and
a second binder resin,
wherein the first binder resin is a block polymer containing at least a polyester skeleton A having, in a repeating structure thereof, a constitutional unit formed by dehydration condensation of hydroxycarboxylic acid, and a skeleton B that does not have, in a repeating structure thereof, a constitutional unit formed by dehydration condensation of hydroxycarboxylic acid, and the first binder resin has glass transition temperature Tg1 and Tg 2 as measured by differential scanning calorimetry at a heating rate of 5° C./min,
wherein the Tg1 is −20° C. to 20° C., and the Tg2 is 35° C. to 65° C., and
wherein the second binder resin is a crystalline resin.
